(19) United States
(12) Patent Application Publication
(10) Pub. No.: US 2021/0201760 A1
(43) Pub. Date: Jul. 1, 2021

(54) PIXEL CIRCUIT AND DRIVING METHOD THEREOF, DISPLAY PANEL AND DRIVING METHOD THEREOF, AND DISPLAY DEVICE

(71) Applicant: BOE TECHNOLOGY GROUP CO., LTD., Beijing (CN)

(72) Inventors: Pengpeng WANG, Beijing (CN); Haisheng WANG, Beijing (CN); Xiaoliang DING, Beijing (CN); Han YUE, Beijing (CN)

(73) Assignee: BOE TECHNOLOGY GROUP CO., LTD., Beijing (CN)

(21) Appl. No.: 16/766,825

(22) PCT Filed: Nov. 26, 2019
(86) PCT No.: PCT/CN2019/120998

§ 371 Date: May 26, 2020

(30) Foreign Application Priority Data
Mar. 20, 2019 (CN) 201910214660.2

(51) Int. Cl. G09G 3/32

(52) U.S. Cl. CPC G09G 3/32; G09G 2310/08; G09G 2310/0272

(57) ABSTRACT

A driving method of a pixel circuit, a driving method of a display panel, a pixel circuit, a display panel, and a display device. In the display period, the driving method of the pixel circuit includes: driving, by the current control circuit and the time control circuit according to the display data signal and the light-emitting control signal received by the current control circuit and the time data signal received by the time control circuit, a light-emitting element to emit light in the plurality of consecutive light-emitting phases; and causing the time control circuit to be turned off in the time control turn-off phase according to a time control turn-off data signal received by the time control circuit.

### CROSS-REFERENCE TO RELATED APPLICATION

This application claims priority to Chinese Patent Application No. 201910214660.2, filed on Mar. 20, 2019, the disclosure of which is incorporated herein by reference in its entirety as part of the present application.

### TECHNICAL FIELD

Embodiments of the present disclosure relate to a driving method of a pixel circuit, a driving method of a display panel, a pixel circuit, a display panel, and a display device.

### BACKGROUND

Micro light-emitting diode display panels are display panels adopting micro light-emitting diodes (micro LEDs, mLEDs or μLEDs). The micro light-emitting diode is a self-luminous component. Compared with ordinary diodes, micro light-emitting diodes have a smaller size (e.g., less than 100 microns, and e.g., 10 microns to 20 microns), higher luminous efficiency, and greater luminous brightness. Therefore, compared with light-emitting diode display panels (e.g., organic light-emitting diode display panels), micro light-emitting diode display panels have higher brightness, lower luminous efficiency and lower operating power consumption, and based on the above characteristics, micro light-emitting diode display panels can be applied to devices with display functions, such as a mobile phone, a display, a notebook computer, a digital camera, an instrument or the like.

The micro LED technology utilizes LED miniaturization and matrix technology, and can provide micro-level red, green, and blue micro LEDs on the array substrate. For example, each micro LED on the array substrate can be used as an independent pixel unit (i.e., can be driven to emit light independently; and for example, different micro LEDs can have different luminous intensities), thereby improving the resolution of the display panel including the array substrate.

### SUMMARY

At least one embodiment of the present disclosure provides a driving method of a pixel circuit, and the pixel circuit comprises a current control circuit and a time control circuit. The current control circuit is configured to receive a display data signal and a light-emitting control signal, control, according to the light-emitting control signal, whether to generate a driving current, and control a current magnitude of the driving current flowing through the current control circuit according to the display data signal; the time control circuit is configured to receive the driving current, receive a time data signal, and control passing time of the driving current according to the time data signal; and a display period of the pixel circuit comprises a plurality of consecutive light-emitting phases and a time control turn-off phase. In the display period, the driving method comprises: driving, by the current control circuit and the time control circuit according to the display data signal and the light-emitting control signal received by the current control circuit and the time data signal received by the time control circuit, a light-emitting element to emit light in the plurality of consecutive light-emitting phases; and causing the time control circuit to be turned off in the time control turn-off phase according to a time control turn-off data signal received by the time control circuit.

At least one embodiment of the present disclosure further provides a driving method of a display panel, the display panel comprises a plurality of pixel circuits, and the plurality of pixel circuits are arranged in a plurality of rows and a plurality of columns. The driving method of the display panel comprises: performing the driving method of the pixel circuit provided by any one of the embodiments of the present disclosure on each of the plurality of pixel circuits.

At least one embodiment of the present disclosure further provides a pixel circuit, and the pixel circuit comprises a current control circuit and a time control circuit. The current control circuit is configured to receive a display data signal and a light-emitting control signal, receive a driving power supply voltage from a first voltage terminal, control whether to generate a driving current according to the light-emitting control signal, and control a current magnitude of the driving current flowing through the current control circuit according to the display data signal; the time control circuit is configured to receive the driving current, receive a time data signal, and control passing time of the driving current according to the time data signal; the current control circuit comprises a first driving transistor and a light-emitting control transistor; the time control circuit comprises a second driving transistor; and the driving current from the first voltage terminal and used for a light-emitting element only passes through the first driving transistor, the second driving transistor, and the light-emitting control transistor.

At least one embodiment of the present disclosure further provides a display panel, including the pixel circuit provided by any one of the embodiments of the present disclosure.

At least one embodiment of the present disclosure further provides a display device, including the pixel circuit provided by any one of the embodiments of the present disclosure or the display panel provided by any one of the embodiments of the present disclosure.

### BRIEF DESCRIPTION OF THE DRAWINGS

In order to clearly illustrate the technical solution of the embodiments of the present disclosure, the drawings of the embodiments will be briefly described in the following. It is obvious that the described drawings in the following are only related to some embodiments of the present disclosure and thus are not limitative of the present disclosure.

FIG. 1 is a schematic diagram of a micro LED substrate;

FIG. 2A is a schematic diagram of a pixel circuit of a micro LED display panel;

FIG. 2B is a timing diagram of driving the pixel circuit illustrated in FIG. 2A;

FIG. 2C is a schematic diagram of the pixel circuit illustrated in FIG. 2A in a reset phase;

FIG. 2D is a schematic diagram of the pixel circuit illustrated in FIG. 2A in a compensation phase;

FIG. 2E is a schematic diagram of the pixel circuit illustrated in FIG. 2A in a time data writing phase;

FIG. 2F is a schematic diagram of the pixel circuit illustrated in FIG. 2A in an effective light-emitting sub-phase;

FIG. 3 is an exemplary block diagram of a pixel circuit provided by at least one embodiment of the present disclosure;

FIG. 4 is another exemplary block diagram of a pixel circuit provided by at least one embodiment of the present disclosure;

FIG. 5 is an exemplary circuit diagram of the pixel circuit illustrated in FIG. 4;

FIG. 6A is a timing diagram of driving the pixel circuit illustrated in FIG. 5;

FIG. 6B is another timing diagram of driving the pixel circuit illustrated in FIG. 5;

FIG. 7A is a schematic diagram of the pixel circuit illustrated in FIG. 5 in a reset phase;

FIG. 7B is a schematic diagram of the pixel circuit illustrated in FIG. 5 in a display data writing and compensation phase;

FIG. 7C is a schematic diagram of the pixel circuit illustrated in FIG. 5 in a time data writing phase;

FIG. 7D is a schematic diagram of the pixel circuit illustrated in FIG. 5 in an effective light-emitting sub-phase;

FIG. 7E is a schematic diagram of the pixel circuit illustrated in FIG. 5 in a time control turn-off phase;

FIG. 8 is another exemplary block diagram of a pixel circuit provided by at least one embodiment of the present disclosure;

FIG. 9 is an exemplary circuit diagram of the pixel circuit illustrated in FIG. 8;

FIG. 10 illustrates an exemplary structural diagram of a display panel provided by at least one embodiment of the present disclosure;

FIG. 11 is a timing diagram of driving a display panel provided by at least one embodiment of the present disclosure;

FIG. 12 is another timing diagram of driving a display panel provided by at least one embodiment of the present disclosure;

FIG. 13 is an exemplary block diagram of a display device provided by at least one embodiment of the present disclosure; and

FIG. 14 is a schematic block diagram of another display device provided by at least one embodiment of the present disclosure.

### DETAILED DESCRIPTION

In order to make objects, technical details and advantages of the embodiments of the disclosure apparent, the technical solutions of the embodiments will be described in a clearly and fully understandable way in connection with the drawings related to the embodiments of the disclosure. Apparently, the described embodiments are just a part but not all of the embodiments of the disclosure. Based on the described embodiments herein, those skilled in the art can obtain other embodiment(s), without any inventive work, which should be within the scope of the disclosure.

Unless otherwise defined, all the technical and scientific terms used herein have the same meanings as commonly understood by one of ordinary skill in the art to which the present disclosure belongs. The terms “first,” “second,” etc., which are used in the description and the claims of the present application for disclosure, are not intended to indicate any sequence, amount or importance, but distinguish various components. Also, the terms “comprise,” “comprising,” “include,” “including,” etc., are intended to specify that the elements or the objects stated before these terms encompass the elements or the objects and equivalents thereof listed after these terms, but do not preclude the other elements or objects. The phrases “connect”, “connected”, “coupled”, etc., are not intended to define a physical connection or mechanical connection, but may include an electrical connection, directly or indirectly. “On,” “under,” “right,” “left” and the like are only used to indicate relative position relationship, and when the position of the object which is described is changed, the relative position relationship may be changed accordingly.

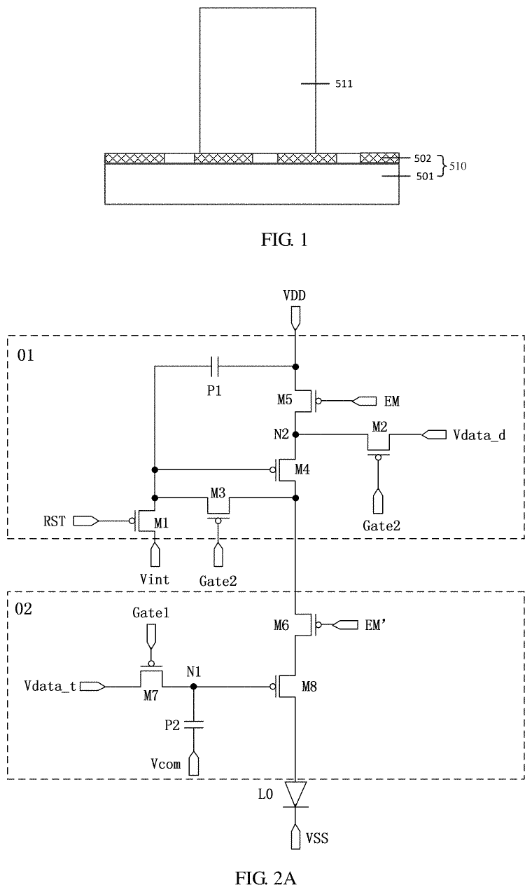

FIG. 1 is a schematic diagram of a micro LED substrate. As illustrated in FIG. 1, the micro LED substrate includes a driving back plate 510 and a micro LED 511 provided on the driving back plate 510. As illustrated in FIG. 1, the driving back plate 510 includes a glass substrate 501 and pixel circuits 502 provided on the glass substrate 501, and the pixel circuits 502 are electrically connected to a corresponding micro LED 511 and are configured to drive the corresponding micro LED 511 to emit light.

For example, the micro LED substrate can be produced by the micro LED transfer technology described below. First, the pixel circuit and the pad electrically connected to the pixel circuit and used to dispose the micro LED are fabricated on the glass substrate; next, the micro LED is fabricated on the semiconductor substrate; and then, the micro LED formed on the semiconductor substrate is transferred to the pad of the glass substrate by the micro LED transfer technology.

The inventors of the present disclosure have noted in research that the operating characteristics of the micro LED at the low current density (i.e., the current density flowing through the micro LED is small) may be unstable (or poor). For example, at the low current density, the luminous efficiency of the micro LED is unstable (or may decrease as the current density decreases). For another example, at the low current density, the color coordinate shift of the micro LED is large (or may change with the change in the current density). In summary, the display effect of the micro LED display panel at the low current density is poor (for example, uneven brightness), and the luminous efficiency is low. Therefore, in order to improve the display effect and/or luminous efficiency of the micro LED display panel, the micro LED in the display panel can be operated to display the low gray level under the high current density (i.e., the current density flowing through the micro LED is large).

The inventors of the present disclosure also have noted in research that in order to enable the micro LED in the display panel to display the low gray level when operating at the high current density, the duration control sub-circuit can be used to reduce the light-emitting time of the micro LED at the high current density (i.e., driven by a data signal of a high gray level) to allow the micro LED to display the low gray level (i.e., allow the brightness of the pixel unit including the micro LED to be lower). However, the inventors of the present disclosure have noted that the above technical solution makes the structure of the pixel circuit of the micro LED display panel complicated (for example, an 8T2C pixel circuit (i.e., a circuit using eight thin film transistors (TFTs) and two capacitors to drive the micro LED to emit light) is usually used), thereby reducing the aperture ratio and resolution of the micro LED display panel, and increasing the difficulty and cost of manufacturing the micro LED display panel.

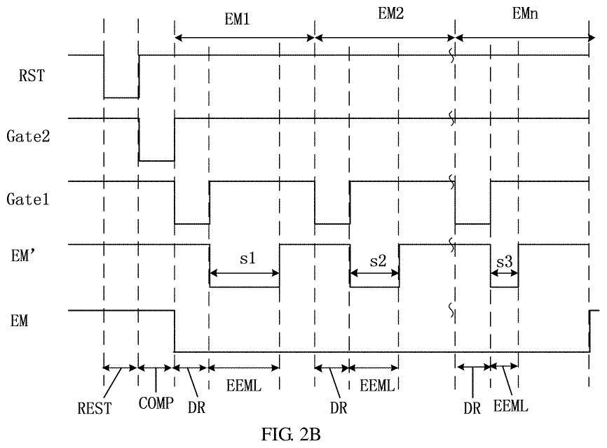

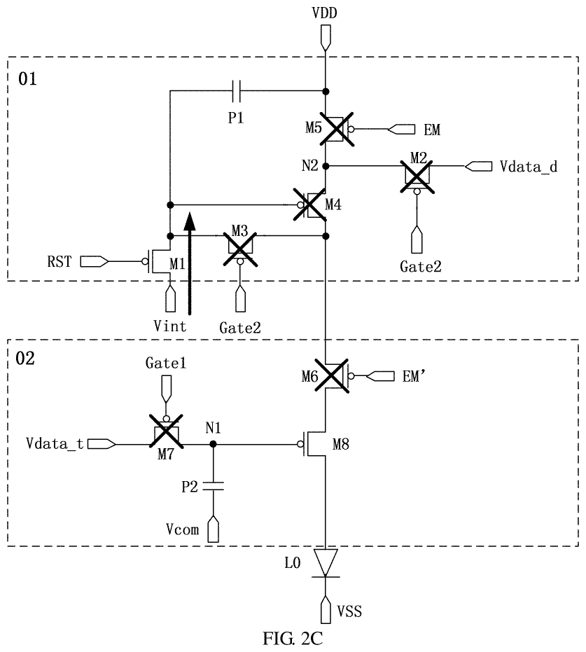

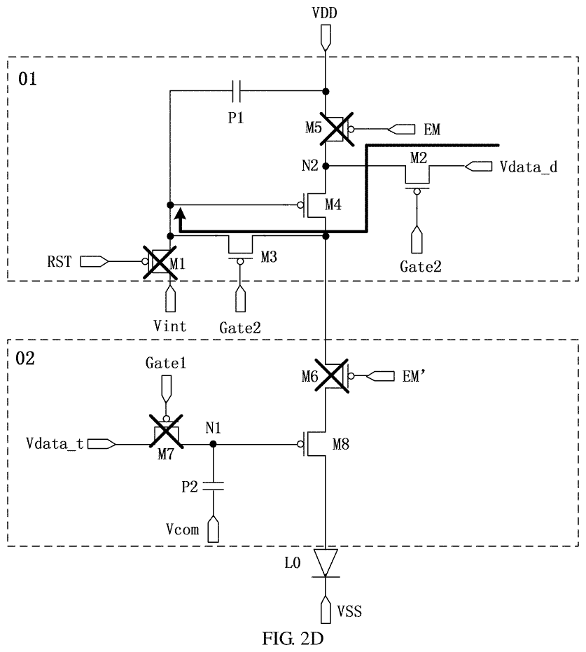

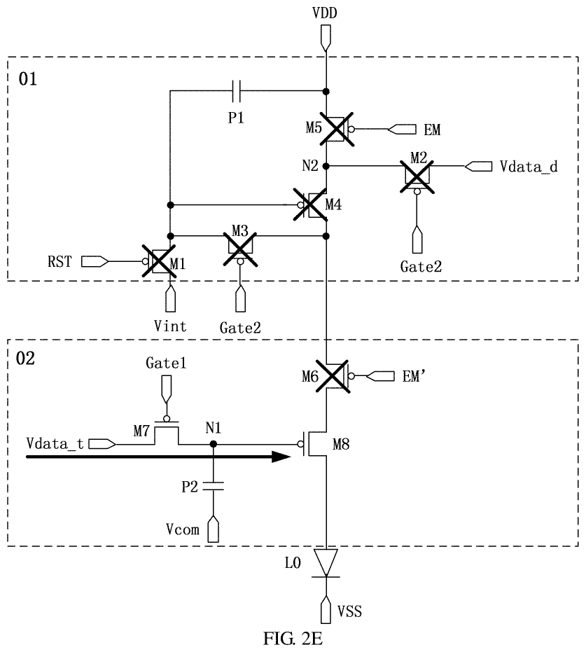

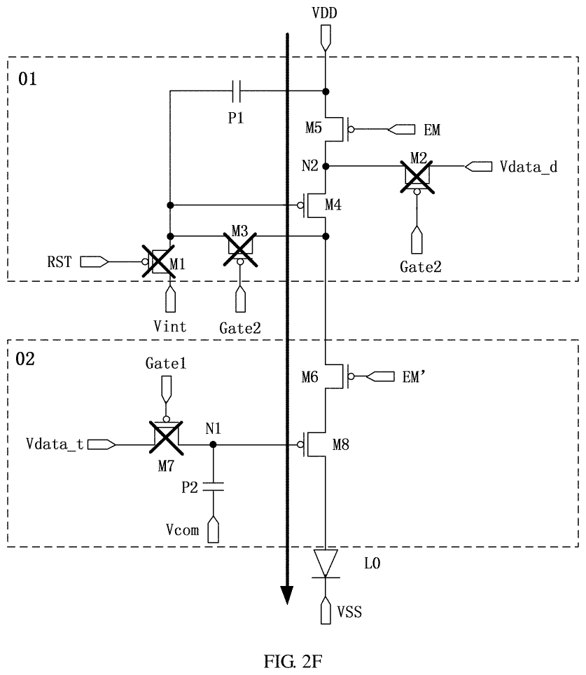

The following is an exemplary description with reference to FIG. 2A and FIG. 2B. FIG. 2A is a schematic diagram of a pixel circuit of a micro LED display panel. As illustrated in FIG. 2A, the pixel circuit of the micro LED display panel is an 8T2C pixel circuit. For convenience of description, FIG. 2A further illustrates the light-emitting element L0.

As illustrated in FIG. 2A, the pixel circuit is electrically connected to the light-emitting element L0 (the anode of the light-emitting element L0) and is used to drive the light-emitting element L0 to emit light; the pixel circuit includes a current control sub-circuit 01 and a duration control sub-circuit 02; and the pixel circuit controls (e.g., modulates) the gray level of the pixel unit including the pixel circuit by controlling the magnitude (or current density) of the current flowing through the light-emitting element and the light-emitting time. For example, the light-emitting element L0 is also connected to the common voltage terminal Vcom (the common voltage line, not illustrated in the figure) to receive the common voltage provided by the common voltage terminal Vcom. For example, the cathode of the light-emitting element L0 is grounded.

As illustrated in FIG. 2A, the current control sub-circuit 01 includes a first transistor M1 to a fifth transistor M5 and a first capacitor P1. Here, the fourth transistor M4 is a driving transistor, and the other transistors are switching transistors. The first transistor M1 to the fifth transistor M5 and the first capacitor P1 cooperate to control the magnitude of the current (i.e., the driving current) flowing through the light-emitting element L0 (i.e., the micro LED). For example, the threshold voltage of the fourth transistor M4 can be compensated for to reduce the shift of the driving current and improve the accuracy of the gray level of the pixel unit including the pixel circuit.

As illustrated in FIG. 2A, the duration control sub-circuit 02 includes a sixth transistor M6 to an eighth transistor M8 and a second capacitor P2, and the sixth transistor M6 to the eighth transistor M8 and the second capacitor P2 cooperate to control the light-emitting time of the light-emitting element L0. An example is described below with reference to FIG. 2B.

For example, the driving timing illustrated in FIG. 2B may be used to drive the pixel circuit illustrated in FIG. 2A. As illustrated in FIG. 2B, in the process of displaying a frame of image, the pixel circuit has a plurality of light-emitting phases. For example, in the process of displaying a frame of image, the pixel circuit has a first light-emitting phase EM1, a second light-emitting phase EM2, . . . , and an N-th light-emitting phase EMn.

The duration control sub-circuit 02 is configured to enable the time data signal Vdata_t to be written to the gate electrode of the eighth transistor M8 multiple times (e.g., n times) in response to a first switching signal (e.g., the switching signal provided by the scanning terminal Gate1), so as to control the turn-on state (being turned on or off) of the eighth transistor M8 subsequent to the time data signal Vdata_t being written and thus control the light-emitting element L0 whether to emit light in each light-emitting phase. The duration control sub-circuit 02 is further configured to control the turn-on state of the sixth transistor M6 (i.e., whether to provide the driving current output by the fourth transistor M4 to the first terminal of the eighth transistor M8) and the turn-on time (e.g., the turn-on time is controlled through the duration of the light-emitting control signal EM′ being at a valid level) in response to the light-emitting control signal EM′, and therefore, the light-emitting time of the light-emitting element L0 (if the light-emitting element L0 emits light) in each light-emitting phase can be controlled. Therefore, the eighth transistor M8 (the time data signal Vdata_t) and the sixth transistor M6 (the light-emitting control signal EM′) of the duration control sub-circuit 02 can cooperate to control the total light-emitting time of the light-emitting element L0.

The working principle of the pixel circuit illustrated in FIG. 2A is exemplarily described below with reference to FIG. 2B to FIG. 2F.

As illustrated in FIG. 2B, in the process of displaying a frame of image, the pixel circuit has a reset phase REST, a compensation phase COMP, and a plurality of light-emitting phases EM1 to EMn, and for example, the reset phase REST, the compensation phase COMP and the plurality of light-emitting phases EM1 to EMn are set sequentially in time. As illustrated in FIG. 2B, each light-emitting phase includes a time data signal writing sub-phase DR and an effective light-emitting sub-phase EEML.

FIG. 2C is a schematic diagram of the pixel circuit illustrated in FIG. 2A in the reset phase REST. As illustrated in FIG. 2B and FIG. 2C, in the reset phase REST, the control terminal of the first transistor M1 connected to the reset scanning terminal RST receives a valid level, and the control terminals of the second transistor M2 to the seventh transistor M7 receive an invalid level. Therefore, in the reset phase REST, only the first transistor M1 is turned on, and the second transistor M2 to the seventh transistor M7 are turned off. In this case, the reset voltage provided by the reset voltage terminal Vint is written to the gate electrode of the fourth transistor M4. For example, the voltage value of the above reset voltage may be low (for example, equal to zero).

As illustrated in FIG. 2C, whether the eighth transistor M8 to be turned on in the reset phase REST is determined by the voltage stored in the second capacitor P2 and applied to the gate electrode (the first node N1) of the eighth transistor M8, that is, determined by the level value of the time data signal written to the second capacitor P2 of the pixel circuit in the last light-emitting phase EMn of displaying the previous frame of image. For example, in the case where the time data signal written to the second capacitor P2 of the pixel circuit in the last light-emitting phase EMn of displaying the previous frame of image is at a valid level, the eighth transistor M8 is turned on in the reset phase REST.

FIG. 2D is a schematic diagram of the pixel circuit illustrated in FIG. 2A in the compensation phase. As illustrated in FIG. 2B and FIG. 2D, in the compensation phase COMP, the second transistor M2 and the third transistor M3 connected to the second scanning terminal Gate2 receive the valid level and thus are in the turn-on state. The first transistor M1, the fifth transistor M5, and the seventh transistor M7 are turned off. In this case, the second transistor M2 connected to the display data terminal Vdata_d allows the display data signal to be written to the first electrode (i.e., the second node) of the fourth transistor M4. Because the voltage value of the reset voltage may be low, the fourth transistor M4 can be turned on, and the voltage (Vdata_d-Vth) of the second electrode of the fourth transistor M4 can be written to the gate electrode of the fourth transistor M4 through the turned-on third transistor M3. Here, Vth is the threshold voltage of the fourth transistor M4.

For example, whether the eighth transistor M8 to be turned on in the compensation phase COMP is also determined by the level value of the time data signal written to the second capacitor P2 of the pixel circuit in the last light-emitting phase EMn of displaying the previous frame of image. For example, in the case where the time data signal written to the second capacitor P2 of the pixel circuit in the last light-emitting phase EMn of displaying the previous frame of image is at a valid level, the eighth transistor M8 is turned on in the compensation phase COMP. Therefore, in order to avoid the leakage of the pixel circuit through the eighth transistor M8 in the compensation phase and further prevent the leakage current from driving the light-emitting element L0 to emit light, in some examples, the sixth transistor M6 is provided in the pixel circuit, and the sixth transistor M6 is turned off in the compensation phase COMP.

FIG. 2E is a schematic diagram of the pixel circuit illustrated in FIG. 2A in the time data writing phase. As illustrated in FIG. 2B and FIG. 2E, in the time data signal writing sub-phase DR, only the seventh transistor M7 connected to the time scanning terminal Gate1 receives the valid level and thus is in the turn-on state, and the first transistor M1 to the sixth transistor M6 are all turned off. In this case, the time data signal provided by the time data terminal Vdata_t is written to the gate electrode of the eighth transistor M8 through the turned-on seventh transistor M7 and stored in the second capacitor P2, and whether the eighth transistor M8 to be turned on depends on the time data signal stored in the second capacitor P2. For example, in the case where the time data signal is at a valid level (for example, a low level), the eighth transistor M8 is turned on.

FIG. 2F is a schematic diagram of the pixel circuit illustrated in FIG. 2A in the effective light-emitting sub-phase EEML. As illustrated in FIG. 2B and FIG. 2F, in the effective light-emitting sub-phase EEML, the light-emitting control signal EM′ and the second light-emitting control signal EM are at a valid level, and therefore, the fifth transistor M5 and the sixth transistor M6 are turned on. In addition, the fourth transistor M4 is turned on, and the driving current Ids generated in the fourth transistor M4 satisfies the following expression (1):

$$\begin{matrix}Ids = {K ( Vs - Vg - Vth )}^{2} \\ = {K ( VDD - ( V data \_ d - Vth ) - Vth )}^{2} \\ = {K ( VDD - V data \_ d )}^{2}\end{matrix}$$

Here, K=½×W/L×C×μ, W is the width of the channel of the fourth transistor M4, L is the length of the channel of the fourth transistor M4, W/L is the width-to-length ratio (i.e., the ratio of width to length) of the channel of the fourth transistor M4, μ is the electron mobility, and C is the capacitance per unit area.

In the case where the time data signal enables the eighth transistor M8 to be turned on, the driving current Ids generated in the fourth transistor M4 is supplied to the light-emitting element L0 through the turned-on sixth transistor M6 and the turned-on eighth transistor M8. Because the driving current Ids generated in the fourth transistor M4 is independent of the threshold voltage Vth of the fourth transistor M4, the accuracy of the gray level of the pixel unit including the above pixel circuit is improved.

For example, the total brightness of the pixel unit including the pixel circuit during displaying a frame of image can be obtained by superimposing the light-emitting brightness of the light-emitting element L0 in the pixel unit in a plurality of (e.g., n) light-emitting phases. Accordingly, the above each frame of image needs to be implemented by the duration control sub-circuit 02 performing a plurality of (e.g., n) time data signal writing operations.

For example, the above pixel circuit and the driving method of the pixel circuit enable the micro LED of the pixel unit to operate at the high current density to display, for example, the low gray level. For example, the light-emitting time (for example, the total length of time the light-emitting control signal EM′ is at a valid level under the condition that the eighth transistor M8 is in the turn-on state) of the micro LED operating at the high current density can be reduced to enable the pixel unit including the micro LED to display the low gray level. For example, the pixel unit including the micro LED can display a desired gray level by controlling the light-emitting time and/or the current density of the driving current of the micro LED operating at the high current density.

For example, the current control sub-circuit 01 and the duration control sub-circuit 02 of the pixel circuit may cooperate with each other to control the total light-emitting time and light-emitting intensity of the light-emitting element L0 in each frame of image, so that the pixel unit including the pixel circuit can display multiple gray levels.

The inventors of the present disclosure have noted that the structure of the 8T2C pixel circuit is complicated, which reduces the aperture ratio and resolution of the micro LED display panel and increases the difficulty and cost of manufacturing the micro LED display panel.

The inventors of the present disclosure also have noted in research that directly reducing the number of transistors of the pixel circuit may reduce the accuracy and/or stability of the brightness of the pixel unit including the pixel circuit and reduce the display uniformity and/or display effect of the display panel including the pixel circuit.

For example, if a current control sub-circuit without a compensation function is provided, although the complexity of the pixel circuit can be reduced, the solution may not only further reduce the accuracy of the gray level of the pixel unit including the pixel circuit at the low current density, but also may reduce the accuracy of the gray level of the pixel unit including the pixel circuit at the high current density.

For example, if the sixth transistor M6 is not provided, it may cause a leakage problem in the pixel circuit during the compensation phase of the pixel circuit, and may cause the light-emitting element connected to the pixel circuit to emit light during the compensation phase of the pixel circuit. Therefore, if the sixth transistor M6 is not provided, not only the compensation effect of the pixel circuit and the accuracy of the gray level of the pixel unit including the pixel circuit may be reduced, but also the contrast and brightness accuracy of the display panel including the pixel circuit may be reduced.

At least one embodiment of the present disclosure provides a driving method of a pixel circuit, a driving method of a display panel, a pixel circuit, a display panel, and a display device. The pixel circuit includes a current control circuit and a time control circuit. The current control circuit is configured to receive a display data signal and a light-emitting control signal, receive a driving power supply voltage from a first voltage terminal, control whether to generate a driving current according to the light-emitting control signal, and control a current magnitude of the driving current flowing through the current control circuit according to the display data signal; the time control circuit is configured to receive the driving current, receive a time data signal, and control passing time of the driving current according to the time data signal; the current control circuit comprises a first driving transistor and a light-emitting control transistor; the time control circuit comprises a second driving transistor; and the driving current from the first voltage terminal and used for a light-emitting element only passes through the first driving transistor, the second driving transistor, and the light-emitting control transistor.

In some examples, by allowing the driving current from the first voltage terminal and used for the light-emitting element to pass only the first driving transistor, the second driving transistor, and the light-emitting control transistor, based on the operating characteristics of the light-emitting element (the micro LED), the structure complexity of the pixel circuit is reduced, the aperture ratio and resolution of the pixel unit including the pixel circuit and the display panel including the pixel circuit are improved, and the manufacturing difficulty and cost of the pixel unit including the pixel circuit and the display panel including the pixel circuit are reduced.

The following provides a non-limiting description of the pixel circuit provided by the embodiments of the present disclosure through several examples. As described below, different features in these specific examples can be combined with each other to obtain new examples in case of no conflict, and these new examples are also within the protection scope of the present disclosure.

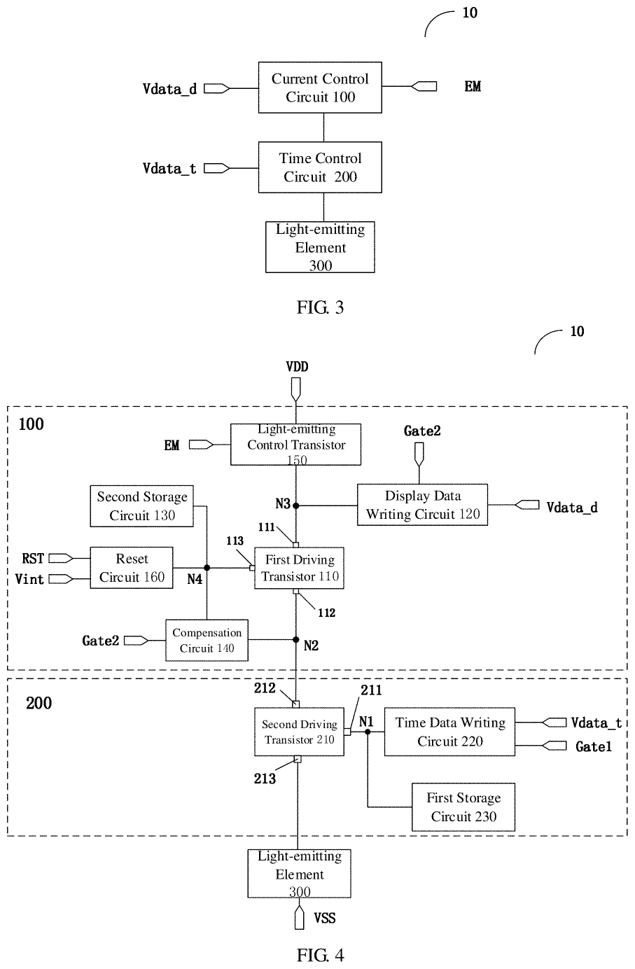

FIG. 3 illustrates a pixel circuit 10 provided by at least one embodiment of the present disclosure, and the driving method of the pixel circuit provided by at least one embodiment of the present disclosure can be applied to the pixel circuit 10 illustrated in FIG. 3.

As illustrated in FIG. 3, the pixel circuit 10 includes a current control circuit 100 and a time control circuit 200. For convenience of description, FIG. 3 and the pixel circuit 10 provided by some embodiments of the present disclosure further illustrates a light-emitting element 300 connected to the pixel circuit 10. For example, the light-emitting element 300 is a micro LED, and the pixel circuit 10 is used to drive the light-emitting element 300 to emit light.

For example, the current control circuit 100 is configured to receive a display data signal and a light-emitting control signal, receive a driving power supply voltage from a first voltage terminal VDD, control whether to generate a driving current according to the light-emitting control signal, and control a current magnitude of the driving current flowing through the current control circuit 100 according to the display data signal.

As illustrated in FIG. 3, the current control circuit 100 includes a display data terminal Vdata_d and a light-emitting control terminal EM, and the display data terminal Vdata_d and the light-emitting control terminal EM are connected to a display data line (not illustrated in the figure) and a light-emitting control line (not illustrated in the figure), respectively, to receive the display data signal and the light-emitting control signal. As illustrated in FIG. 3, the current control circuit 100 is also connected to the first voltage terminal VDD (not illustrated in the figure) to receive the driving power supply voltage.

For example, the current control circuit 100 controls whether to generate a driving current according to the light-emitting control signal, and controls a current magnitude of the driving current flowing through the current control circuit 100 according to the display data signal (e.g., the display data voltage). For example, the display data signal is in negative correlation with the current magnitude of the driving current flowing through the current control circuit 100. For example, the current control circuit 100 generates a driving current in the case where the light-emitting control signal is a valid signal (at a valid level, for example, a low level), and no driving current is generated in the case where the light-emitting control signal is an invalid signal (at an invalid level, for example, a high level; the voltage value of the high level being greater than the voltage value of the low level). For example, the duration of the valid signal determines the time of the driving current generated in each light-emitting phase, and thus can be used to control the light-emitting time of the light-emitting element 300 in each light-emitting phase.

It should be noted that in at least one embodiment of the present disclosure, the valid signal (level) refers to a signal (level) used to turn on the corresponding switching element, and the invalid signal (level) refers to a signal (level) used to turn off the corresponding switching element.

As illustrated in FIG. 3, the current control circuit 100 is connected to an output terminal of the time control circuit 200, and can provide the driving current to the time control circuit 200, so that the current control circuit 100 can provide the driving current to the light-emitting element 300 through the time control circuit 200 in practice.

As illustrated in FIG. 3, the time control circuit 200 includes a driving current receiving terminal and a time data signal receiving terminal Vdata_t, and the driving current receiving terminal and the time data signal receiving terminal Vdata_t are respectively connected to the output terminal of the current control circuit 100 and a time data line (not illustrated in the figure) to receive the driving current and the time data signal (e.g., the time data voltage), respectively. The time control circuit 200 is configured to control the passing time of the driving current according to the time data signal. For example, the time control circuit 200 is configured to control, based on the time data signal, the number of times that the light-emitting element 300 emits light during the period of displaying a frame of image, and thus can be used to control the total time of the driving current flowing through the light-emitting element 300 during the period of displaying the frame of image. In summary, the current control circuit 100 and the time control circuit 200 cooperate to drive the light-emitting element 300 to emit light according to the display data signal and the light-emitting control signal received by the current control circuit 100 and the time data signal received by the time control circuit 200.

As illustrated in FIG. 3, the light-emitting element 300 is configured to receive the driving current and emit light according to the current magnitude and the passing time of the driving current. For example, the light-emitting element 300 is connected to the output terminal of the time control circuit 200 and a second voltage terminal (not illustrated in the figure) or a second voltage line (not illustrated in the figure) additionally provided, to receive the driving current provided by the time control circuit 200 and the second level signal (the second voltage) provided by the second voltage terminal, respectively. For example, the second voltage output by the second voltage terminal is smaller than the driving power supply voltage output by the first voltage terminal.

For example, in the case where the time control circuit 200 is turned on and provides the driving current from the current control circuit 100 to the light-emitting element 300, the light-emitting element 300 emits light according to the current magnitude of the driving current; and in the case where the time control circuit 200 is turned off, the light-emitting element 300 does not emit light.

For example, through the cooperation of the light-emitting control signal and the time data signal, the number of times that the light-emitting element emits light during the process of displaying a frame of image and the duration and intensity of each light emission can be controlled, so that the pixel unit including the pixel circuit can display the required gray level according to the application requirements.

FIG. 4 illustrates an example of the pixel circuit 10 illustrated in FIG. 3. As illustrated in FIG. 4, the current control circuit 100 includes a first driving transistor 110 and a light-emitting control transistor 150; the time control circuit 200 includes a second driving transistor 210; and in practice, the driving current from the first voltage terminal VDD and used for the light-emitting element 300 only passes through (prior to being provided to the light-emitting element 300) the first driving transistor 110, the second driving transistor 120, and the light-emitting control transistor 150.

For example, as illustrated in FIG. 2A, a second terminal 112 of the first driving transistor 110 is connected (for example, directly connected) to a first terminal 212 of the second driving transistor 210; and a second terminal 213 of the second driving transistor 210 is connected (for example, directly connected) to the first terminal of the light-emitting element 300.

For example, as illustrated in FIG. 2A, no other transistors are provided between the second terminal 112 of the first driving transistor 110 and the first terminal 212 of the second driving transistor 210, and/or no other transistors are provided between the second terminal 213 of the second driving transistor 210 and the light-emitting element 300.

For example, compared to the pixel circuit 10 illustrated in FIG. 2A, the pixel circuit 10 illustrated in FIG. 4 is provided with only one light-emitting control transistor 150, and no other light-emitting control transistor is provided between, for example, the first driving transistor 110 and the second driving transistor 210, so that the driving current from the first voltage terminal VDD and used for driving the light-emitting element 300 only passes through (prior to being provided to the light-emitting element 300) the first driving transistor 110, the second driving transistor 120, and the light-emitting control transistor 150. In this case, the number of transistors of the pixel circuit 10 can be reduced, thereby reducing the structure complexity of the pixel circuit 10, improving the aperture ratio and resolution of the pixel unit including the pixel circuit 10 and the display panel including the pixel circuit 10, and reducing the difficulty and cost of manufacturing the pixel unit including the pixel circuit 10 and the display panel including the pixel circuit 10.

For example, in the pixel circuit 10 illustrated in FIG. 4, the second driving transistor 210 is configured to control whether or not the light-emitting element 300 emits light in each light-emitting phase in response to the time data signal (received by the control terminal of the second driving transistor 210), that is, control the number of times that the light-emitting element 300 emits light during the process of displaying a frame of image; the light-emitting control transistor 150 is configured to control the duration of the driving current in each light-emitting phase and the light-emitting time of the light-emitting element 300 in each light-emitting phase in response to the light-emitting control signal (received by the control terminal of the light-emitting control transistor 150); and the first driving transistor 110 is configured to control the current magnitude of the driving current in each light-emitting phase in response to the display data signal, and the light-emitting intensity of the light-emitting element 300 in each light-emitting phase.

Therefore, the pixel circuit illustrated in FIG. 4 and the driving method of the pixel circuit illustrated in FIG. 4 enable the light-emitting element 300 (for example, the micro LED) of the pixel unit to display, for example, a low gray level (for example, 1) when operating at a high current density. For example, according to practical application requirements, the light-emitting element 300 (e.g., the micro LED) can also display a medium gray level (e.g., 125) or a high gray level (e.g., 255) when operating at a high current density. For example, according to practical application requirements, the pixel unit including the micro LED can display the low gray level by reducing the light-emitting time of the micro LED operating at the high current density. For example, the pixel unit including the micro LED can display the desired gray level by controlling the light-emitting time of the micro LED operating at the high current density and/or the current density of the driving current.

The current control circuit provided by at least one embodiment of the present disclosure is exemplarily described below with reference to FIG. 4.

As illustrated in FIG. 4, in addition to the light-emitting control transistor 150 and the first driving transistor 110, the current control circuit 100 further includes a display data writing circuit 120, a second storage circuit 130, a compensation circuit 140, and a reset circuit 160. For convenience of description, a first node N1, a second node N2, a third node N3, and a fourth node N4 are provided in the pixel circuit illustrated in FIG. 4.

As illustrated in FIG. 4, the light-emitting control transistor 150 includes a first terminal, a second terminal, and a control terminal. The control terminal of the light-emitting control transistor 150 is configured to be connected to a light-emitting control line (a light-emitting control terminal EM) to receive the light-emitting control signal. The first terminal of the light-emitting control transistor 150 is connected to the first voltage terminal VDD (or the first voltage line) to receive the driving power supply voltage provided by the first voltage terminal VDD. For example, the first voltage terminal VDD is configured to continuously provide a direct-current level signal. The second terminal of the light-emitting control transistor 150 is connected to the first terminal 111 (the third node N3) of the first driving transistor 110, and the light-emitting control transistor 150 is configured to apply the driving power supply voltage of the first voltage terminal VDD to the first terminal 111 of the first driving transistor 110 in response to the light-emitting control signal.

For example, the light-emitting control transistor 150 may be turned on in response to the light-emitting control signal provided by the light-emitting control terminal EM, so that the driving power supply voltage may be applied to the first terminal 111 (the third node N3) of the first driving transistor 110. For example, in the case where the second driving transistor 210 is turned on, the light-emitting control transistor 150 is configured to control the duration of light emission of the light-emitting element 300 in each light-emitting phase in response to the light-emitting control signal and the location of the light-emitting period in the light-emitting phase. For example, the current control circuit 100 may be configured to control the duration of light emission of the light-emitting element in each light-emitting phase.

As illustrated in FIG. 4, the first driving transistor 110 includes a first terminal 111, a second terminal 112, and a control terminal 113, and is configured to receive a display data signal, generate the driving current, and control the current magnitude of the driving current according to the display data signal. As illustrated in FIG. 4, the control terminal 113 of the first driving transistor 110 is connected to the second storage circuit 130 (the fourth node N4), the first terminal 111 of the first driving transistor 110 is connected to the light-emitting control transistor 150, and the second terminal 112 of the first driving transistor 110 is connected to the time control circuit 200 (the second node N2). The first driving transistor 110 is configured to control the current magnitude of the driving current (for example, the current magnitude of the driving current in each light-emitting phase) in response to the display data signal, and thus can control the light-emitting intensity of the light-emitting element in each light-emitting phase.

For example, the first driving transistor 110 may provide the driving current to the light-emitting element 300 through the time control circuit 200 (e.g., the second driving transistor 210 in the time control circuit 200) to drive the light-emitting element 300 to emit light, and may drive the light-emitting element 300 to emit light according to the display data signal (i.e., the desired gray level).

As illustrated in FIG. 4, the display data writing circuit 120 is connected to the first terminal 111 (the third node N3) of the first driving transistor 110 and is configured to write the display data signal to the first terminal 111 of the first driving transistor 110 in response to the current scanning signal. For example, the display data writing circuit 120 is connected to the display data line (the display data terminal Vdata_d), the first terminal 111 (the third node N3) of the first driving transistor 110, and the current scanning line (the current scanning terminal Gate2). For example, the current scanning signal from the current scanning terminal Gate2 is applied to the display data writing circuit 120 to control whether to turn on the display data writing circuit 120 or not. For example, the display data writing circuit 120 can be turned on in response to the current scanning signal, so that the display data signal provided by the display data terminal Vdata_d can be written to the first terminal 111 (the third node N3) of the first driving transistor 110, and then the display data signal is stored in the second storage circuit 130 through the first driving transistor 110 to generate the driving current for driving the light-emitting element 300 to emit light according to the display data signal.

It should be noted that the display data writing circuit 120 provided by at least one embodiment of the present disclosure is not limited to being connected to the first terminal of the first driving transistor 110. In some examples (for example, in the case where the pixel circuit 10 does not include the compensation circuit 140 and the reset circuit 160), the display data writing circuit 120 may also be connected to the control terminal 113 of the first driving transistor 110, so that the display data signal is written to the control terminal 113 of the first driving transistor 110 and stored in the second storage circuit 130.

As illustrated in FIG. 4, the second storage circuit 130 is connected to the control terminal 113 (the fourth node N4) of the first driving transistor 110, and is configured to store the display data signal written by the display data writing circuit 120. For example, the second storage circuit 130 may store the display data signal, and therefore, the display data signal stored in the second storage circuit 130 can be used to control the first driving transistor 110. For example, the display data signal stored in the second storage circuit 130 can be used to control the turn-on degree of the first driving transistor 110, so that the magnitude of the driving current generated by the first driving transistor 110 can be controlled. In other examples, the second storage circuit 130 may further be connected to the first voltage terminal VDD or a high voltage terminal additionally provided to implement the voltage storage function.

As illustrated in FIG. 4, the compensation circuit 140 is connected to the current scanning line (the current scanning terminal Gate2) to receive the current scanning signal provided by the current scanning terminal Gate2, and the current scanning signal is used to control whether to turn on the compensation circuit 140 or not. The compensation circuit 140 is connected to the control terminal 113 (the fourth node N4) of the first driving transistor 110 and the second terminal 112 (the second node N2) of the first driving transistor 110, and is configured to compensate for the first driving transistor 110 in response to the current scanning signal and the display data signal written to the first terminal 111 of the first driving transistor 110.

For example, the compensation circuit 140 may be turned on in response to the current scanning signal (the current scanning signal provided by the current scanning terminal Gate2) to electrically connect the control terminal 113 (the fourth node N4) of the first driving transistor 110 to the second terminal 112 (the second node N2) of the first driving transistor 110, so that both the threshold voltage information of the first driving transistor 110 and the display data signal written by the display data writing circuit 120 are stored in the second storage circuit 130. Therefore, the voltage value including the display data signal and the threshold voltage information stored in the second storage circuit 130 can be used to control the driving current generated by the first driving transistor 110, so that the driving current output by the first driving transistor 110 is the compensated driving current. For example, the compensated driving current is independent of the threshold voltage of the first driving transistor 110.

As illustrated in FIG. 4, the reset circuit 160 is connected to the control terminal 113 (the fourth node N4) of the first driving transistor 110, and is configured to apply the reset voltage provided by the reset voltage terminal Vint to the control terminal 113 of the first driving transistor 110 in response to the reset scanning signal. For example, the reset circuit 160 is connected to the fourth node N4, the reset voltage terminal Vint, and the reset scanning line (the reset scanning terminal RST). For example, the reset circuit 160 may be turned on in response to the reset scanning signal provided by the reset scanning signal terminal RST, and apply the reset voltage provided by the reset voltage terminal Vint to the control terminal 113 (the fourth node N4) of the first driving transistor 110, thereby performing the reset operation on the first driving transistor 110 and the second storage circuit 130 to eliminate the influence of the previous light-emitting phase. In addition, the reset voltage applied by the reset circuit 160 may also be stored in the second storage circuit 130 to allow the first driving transistor 110 to be turned on, so that when the display data signal is written next time, it is convenient for the display data signal to be written in the second storage circuit 130 through the first driving transistor 110 and the compensation circuit 140.

It should be noted that the current control circuit 100 provided by at least one embodiment of the present disclosure is not limited to the structure illustrated in FIG. 4. For example, according to practical application requirements, the current control circuit 100 may include only the light-emitting control transistor 150, the first driving transistor 110, the display data writing circuit 120, and the second storage circuit 130, but does not include the compensation circuit 140 and the reset circuit 160, which may further simplify the structure of the pixel circuit provided by at least one embodiment of the present disclosure. For example, the current control circuit 100 may also use other suitable structures, as long as the current control circuit 100 has the function of controlling the magnitude of the driving current and the function of controlling the duration (in each light-emitting phase) of the driving current.

The time control circuit provided by at least one embodiment of the present disclosure is exemplarily described below with reference to FIG. 4.

As illustrated in FIG. 4, in addition to including the second driving transistor 210, the time control circuit 200 includes, for example, a time data writing circuit 220 and a first storage circuit 230.

As illustrated in FIG. 4, the second driving transistor 210 includes a control terminal 211, a first terminal 212, and a second terminal 213, and is configured to control whether to turn on the second driving transistor 210 or not and control whether or not to provide the driving current to the light-emitting element 300 through the second driving transistor 210 in response to the time data signal. For example, the first terminal 212 of the second driving transistor 210 is directly connected to the second terminal 112 (the second node N2) of the first driving transistor 110 to receive the driving current generated by the first driving transistor 110. The second terminal 213 of the second driving transistor 210 is connected to the light-emitting element 300 to provide the driving current generated by the first driving transistor 110 to the light-emitting element 300. The control terminal 211 of the second driving transistor 210 is connected to the first node N1 to receive the time data signal written to the first node N1. For example, the second driving transistor 210 may be turned on or turned off under the control of the time data signal in practice, so as to provide the driving current to the light-emitting element 300 or not to provide the driving current to the light-emitting element 300.

It should be noted that the first terminal 212 of the second driving transistor 210 being directly connected to the second terminal 112 (the second node N2) of the first driving transistor 110 means that no other transistor is provided between the first terminal 212 of the second driving transistor 210 and the second terminal 112 of the first driving transistor 110. For example, no other transistor is provided between the second terminal 213 of the second driving transistor 210 and the light-emitting element 300.

As illustrated in FIG. 4, the time data writing circuit 220 is connected to the control terminal 211 (the first node N1) of the second driving transistor 210 and is configured to write the time data signal to the control terminal 211 of the second driving transistor 210 in response to the time scanning signal. For example, the time data writing circuit 220 is connected to the time data line (the time data terminal Vdata_t) and the time scanning line (the time scanning terminal Gate1) to receive the time data signal provided by the time data terminal Vdata_t and the time scanning signal provided by the time scanning terminal Gate1, respectively. For example, the time data writing circuit 220 can be turned on in response to the time scanning signal, so that the time data signal can be written to the control terminal 211 (the first node N1) of the second driving transistor 210, and further the time data signal can be stored in the first storage circuit 230.

As illustrated in FIG. 4, the first storage circuit 230 is connected to the control terminal 211 (the first node N1) of the second driving transistor 210, and is configured to store the time data signal written by the time data writing circuit 220. The first storage circuit 230 may also be connected to a voltage terminal additionally provided (for example, the common voltage terminal Vcom described below) to implement the voltage storage function. For example, the turn-on state of the second driving transistor 210 can be controlled by using the time data signal stored in the first storage circuit 230.

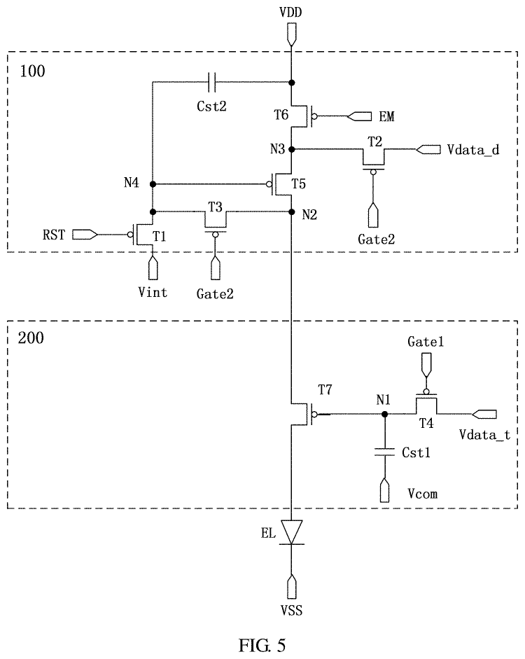

FIG. 5 is an example of the pixel circuit illustrated in FIG. 4. As illustrated in FIG. 5, the pixel circuit 10 includes the first transistor T1 to the seventh transistor T7 and further includes the first capacitor Cst1 and the second capacitor Cst2. For example, the fifth transistor T5 is used as a driving transistor, and the other transistors are used as switching transistors. For clarity, FIG. 5 also illustrates the light-emitting element EL. For example, the light-emitting element EL may be a micro LED of various types, the micro LED may emit red light, green light, blue light, white light, or the like, and the embodiments of the present disclosure are not limited in this aspect.

As illustrated in FIG. 5, the light-emitting control transistor 150 illustrated in FIG. 4 may be implemented as the sixth transistor T6. The gate electrode of the sixth transistor T6 is configured to be connected to the light-emitting control line (the light-emitting control terminal EM) to receive the light-emitting control signal; the first electrode of the sixth transistor T6 is configured to be connected to the common voltage terminal VDD; and the second electrode of the sixth transistor T6 is configured to be connected to the first terminal (the third node N3) of the first driving transistor 110 (that is, the fifth transistor T5).

As illustrated in FIG. 5, the first driving transistor 110 illustrated in FIG. 4 may be implemented as the fifth transistor T5. The gate electrode (as the control terminal 113 of the first driving transistor 110 illustrated in FIG. 4) of the fifth transistor T5 is connected to the fourth node N4; the first electrode (as the first terminal 111 of the first driving transistor 110 illustrated in FIG. 4) of the fifth transistor T5 is connected to the third node N3; and the second electrode (as the second terminal 112 of the first driving transistor 110 illustrated in FIG. 4) of the fifth transistor T5 is connected to the second node N2 and is configured to be connected to the time control circuit 200.

As illustrated in FIG. 5, the display data writing circuit 120 illustrated in FIG. 4 may be implemented as the second transistor T2. The gate electrode of the second transistor T2 is configured to be connected to the current scanning line (the current scanning terminal Gate2) to receive the current scanning signal; the first electrode of the second transistor T2 is configured to be connected to the display data line (the display data terminal Vdata_d) to receive the display data signal; and the second electrode of the second transistor T2 is configured to be connected to the first terminal (the third node N3) of the fifth transistor T5. It should be noted that, in the embodiments of the present disclosure, the connection relationship of the second transistor T2 and the fifth transistor T5 is not limited to the example illustrated in FIG. 5. For example, in other examples, in the case where the compensation circuit 140 is not included, the second electrode of the second transistor T2 may also be connected to the gate electrode of the fifth transistor T5 to write the display data signal to the gate electrode of the fifth transistor T5. The display data writing circuit 120 may be a circuit formed by other components, and the embodiments of the present disclosure are not limited in this aspect.

As illustrated in FIG. 5, the second storage circuit 130 illustrated in FIG. 4 may be implemented as the second capacitor Cst2. The first electrode of the second capacitor Cst2 is configured to be connected to the gate electrode (the fourth node N4) of the fifth transistor T5, and the second electrode of the second capacitor Cst2 is configured to be connected to the common voltage terminal VDD to receive the driving power supply voltage. It should be noted that the embodiments of the present disclosure are not limited in this aspect, and the second storage circuit 130 may also be a circuit composed of other components. For example, the second storage circuit 130 may include two capacitors which are connected in parallel/series.

As illustrated in FIG. 5, the compensation circuit 140 illustrated in FIG. 4 may be implemented as the third transistor T3. The gate electrode of the third transistor T3 is configured to be connected to the current scanning line (the current scanning terminal Gate2) to receive the current scanning signal; the first electrode of the third transistor T3 is configured to be connected to the gate electrode (the fourth node N4) of the fifth transistor T5; and the second electrode of the third transistor T3 is configured to be connected to the second electrode (the second node N2) of the fifth transistor T5. It should be noted that the embodiments of the present disclosure are not limited in this aspect, and the compensation circuit 140 may also be a circuit composed of other components.

As illustrated in FIG. 5, the reset circuit 160 illustrated in FIG. 4 may be implemented as the first transistor T1. The gate electrode of the first transistor T1 is configured to be connected to the reset signal line (the reset signal terminal RST) to receive the reset scanning signal; the first electrode of the first transistor T1 is configured to be connected to the gate electrode (the fourth node N4) of the fifth transistor T5; and the second electrode of the first transistor T1 is configured to be connected to the reset voltage terminal Vint to receive the reset voltage. It should be noted that the embodiments of the present disclosure are not limited in this aspect, and the reset circuit 160 may also be a circuit composed of other components.

As illustrated in FIG. 5, the second driving transistor 210 illustrated in FIG. 4 may be implemented as the seventh transistor T7. The gate electrode (as the control terminal 211 of the second driving transistor 210 illustrated in FIG. 4) of the seventh transistor T7 is connected to the first node N1; the first electrode (as the first terminal 212 of the second driving transistor 210 illustrated in FIG. 4) of the seventh transistor T7 is connected to the second node N2 and the second electrode of the fifth transistor T5; and the second electrode of the seventh transistor T7 is configured to be connected to the light-emitting element EL (for example, to the anode of the light-emitting element EL).

As illustrated in FIG. 5, the time data writing circuit 220 illustrated in FIG. 4 may be implemented as the fourth transistor T4. The gate electrode of the fourth transistor T4 is configured to be connected to the time scanning line (the time scanning terminal Gate1) to receive the time scanning signal; the first electrode of the fourth transistor T4 is configured to be connected to the time data line (the time data terminal Vdata_t) to receive the time data signal; and the second electrode of the fourth transistor T4 is configured to be connected to the gate electrode (the first node N1) of the seventh transistor T7. It should be noted that the embodiments of the present disclosure are not limited in this aspect, and the time data writing circuit 220 may also be a circuit composed of other components.

As illustrated in FIG. 5, the first storage circuit 230 illustrated in FIG. 4 may be implemented as the first capacitor Cst1. The first electrode of the first capacitor Cst1 is configured to be connected to the gate electrode (the first node N1) of the seventh transistor T7; and the second electrode of the first capacitor Cst1 is configured to be connected to the common voltage terminal Vcom to receive the common voltage. For example, the common voltage terminal Vcom is configured to provide a direct-current level signal (e.g., grounded). It should be noted that the embodiments of the present disclosure are not limited in this aspect, and the first storage circuit 230 may also be a circuit composed of other components.

As illustrated in FIG. 5, the light-emitting element 300 illustrated in FIG. 4 may be implemented as the light-emitting element EL (for example, a micro LED). The first terminal (the anode in this embodiment) of the light-emitting element EL is connected to the second electrode of the seventh transistor T7, and the second terminal (the cathode in this embodiment) of the light-emitting element EL is connected to the second voltage terminal VSS to receive the second voltage. For example, the second voltage terminal VSS is configured to continuously provide a direct-current level signal. For example, the voltage value of the direct-current level signal provided by the second voltage terminal VSS is less than the voltage value of the direct-current level signal provided by the first voltage terminal VDD. For example, the second voltage terminal VSS is grounded. For example, in some examples, the second voltage terminal VSS may be connected to the same voltage terminal as the common voltage terminal Vcom. In an example of a display panel, the display panel may include a plurality of pixel circuits 10 arranged in an array, and in this case, the cathodes of the light-emitting elements EL of the plurality of pixel circuits 10 may be electrically connected to the same voltage terminal, that is, adopting the common cathode connection approach.

At least one embodiment of the present disclosure provides a driving method of a pixel circuit. The pixel circuit includes a current control circuit and a time control circuit. The current control circuit is configured to receive a display data signal and a light-emitting control signal, control whether to generate a driving current according to the light-emitting control signal, and control a current magnitude of the driving current flowing through the current control circuit according to the display data signal; the time control circuit is configured to receive the driving current, receive a time data signal, and control passing time of the driving current according to the time data signal; and a display period of the pixel circuit includes a plurality of consecutive light-emitting phases and a time control turn-off phase. In the display period, the driving method of the pixel circuit includes: driving, by the current control circuit and the time control circuit according to the display data signal and the light-emitting control signal received by the current control circuit and the time data signal received by the time control circuit in the plurality of consecutive light-emitting phases, a light-emitting element to emit light; and allowing the time control circuit to be turned off according to a time control turn-off data signal received by the time control circuit in the time control turn-off phase.

In some examples, by setting the time control turn-off phase, based on the operating characteristics of the light-emitting element (the micro LED), the structure complexity of the pixel circuit can be reduced, the aperture ratio and resolution of the pixel unit including the pixel circuit and the display panel including the pixel circuit can be improved, and the difficulty and cost of manufacturing the pixel unit including the pixel circuit and the display panel including the pixel circuit can be reduced.

The driving method of the pixel circuit provided by the embodiments of the present disclosure is described below in combination with the timing diagram for driving the pixel circuit. As described below, different features in these specific examples can be combined with each other to obtain new examples in case of no conflict, and these new examples are also within the protection scope of the present disclosure.

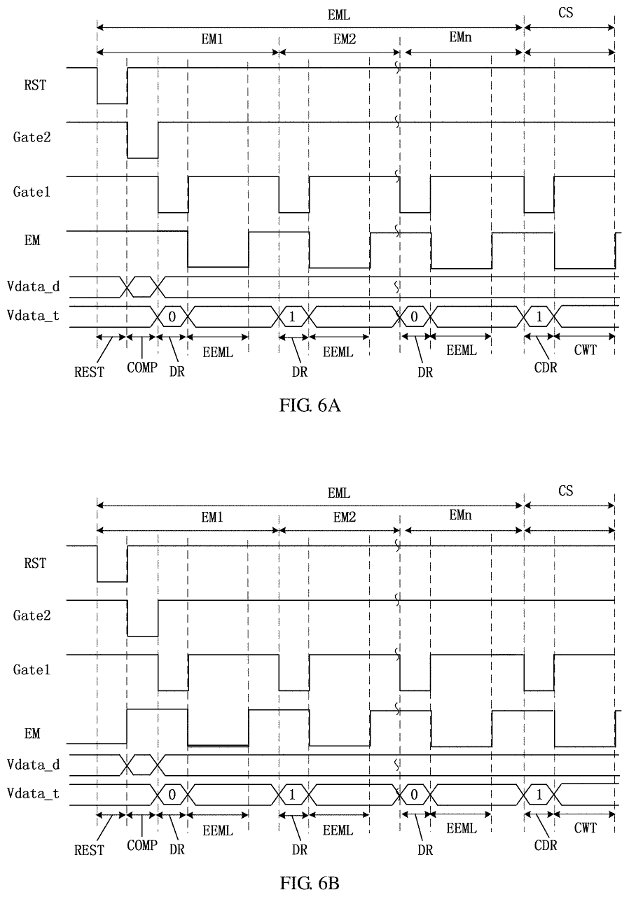

FIG. 6A is a timing diagram of driving the pixel circuit 10 illustrated in FIG. 4 and FIG. 5. The driving method of the pixel circuit provided by at least one embodiment of the present disclosure is exemplarily described below with reference to the pixel circuit 10 illustrated in FIG. 4 and FIG. 5 and the driving timing diagram illustrated in FIG. 6A.

It should be noted that the example illustrated in FIG. 6A and other examples of the embodiments of the present disclosure are described by taking the case where each transistor of the pixel circuit is a P-type transistor as an example, that is, the gate electrode of each transistor is turned on when receiving a low level and turned off when receiving a high level, but the embodiments of the present disclosure are not limited thereto.

As illustrated in FIG. 6A, the display period (that is, the period corresponding to the display of a frame of image of the display panel including the pixel circuit) of the pixel circuit 10 includes a plurality of consecutive light-emitting phases (EM1, EM2, . . . , EMn) and a time control turn-off phase CS. The plurality of consecutive light-emitting phases are referred to as a total light-emitting phase EML. For example, the light-emitting phases EM1, EM2, . . . , EMn are sequentially connected in time. For example, the total light-emitting phase EML and the time control turn-off phase CS are directly connected in time.

For example, in the display period of the pixel circuit 10, the driving method includes the following steps S110 and S120.

Step S110: driving, by the current control circuit 100 and the time control circuit 200 according to the display data signal and the light-emitting control signal received by the current control circuit 100 and the time data signal received by the time control circuit 200 in the plurality of consecutive light-emitting phases (EM1, EM2, . . . , EMn), the light-emitting element EL to emit light.

Step S120: allowing the time control circuit 200 to be turned off according to a time control turn-off data signal received by the time control circuit 200 in the time control turn-off phase CS.

In some examples, the time control circuit 200 is turned off (the time control circuit 200 is turned off in the time control turn-off phase CS) according to the time control turn-off data signal received by the time control circuit 200, so that in the case where no other transistor is provided between the fifth transistor T5 and the seventh transistor T7, the pixel circuit 10 is prevented from leaking in the compensation phase of the next display period, and thus the light emission of the light-emitting element EL caused by the leakage current can be avoided. Therefore, the structure complexity of the pixel circuit 10 provided by at least one embodiment of the present disclosure may be reduced, the aperture ratio and resolution of the pixel unit including the pixel circuit 10 and the display panel including the pixel circuit 10 may be improved, and the difficulty and cost of manufacturing the pixel unit including the pixel circuit 10 and the display panel including the pixel circuit 10 may be reduced.

For example, according to practical application requirements, the display period of the pixel circuit 10 further includes a reset phase REST and a display data writing and compensation phase COMP. For example, the reset phase REST and the display data writing and compensation phase COMP are connected in time (for example, sequentially connected).

In an example, as illustrated in FIG. 6A, only the initial light-emitting phase (that is, the first light-emitting phase in the plurality of consecutive light-emitting phases; for example, the first light-emitting phase EM1 illustrated in FIG. 6A) in the plurality of continuous light-emitting phases includes the reset phase REST and the display data writing and compensation phase COMP. In another example, each light-emitting phase includes the reset phase REST and the display data writing and compensation phase COMP. In still another example, the initial light-emitting phase and part of the light-emitting phases other than the initial light-emitting phase may include the reset phase REST and the display data writing and compensation phase COMP.

As illustrated in FIG. 6A, each light-emitting phase includes an effective light-emitting sub-phase EEML and a time data writing sub-phase DR prior to the effective light-emitting sub-phase EEML. For example, in the case where the light-emitting phase has the reset phase REST and the display data writing and compensation phase COMP, the reset phase REST and the display data writing and compensation phase COMP are prior to the time data writing sub-phase DR and the effective light-emitting sub-phase EEML in time.

As illustrated in FIG. 6A, the driving method of the pixel circuit 10 further includes the following steps S130 and S140.

Step S130: providing a first reset signal to the current control circuit 100 in the reset phase REST to reset the current control circuit 100.

Step S140: writing the display data signal to the first driving transistor 110 and performing threshold compensation on the first driving transistor 110 in the display data writing and compensation phase COMP to controlling a current magnitude of a driving current flowing through the first driving transistor 110 according to the display data signal.

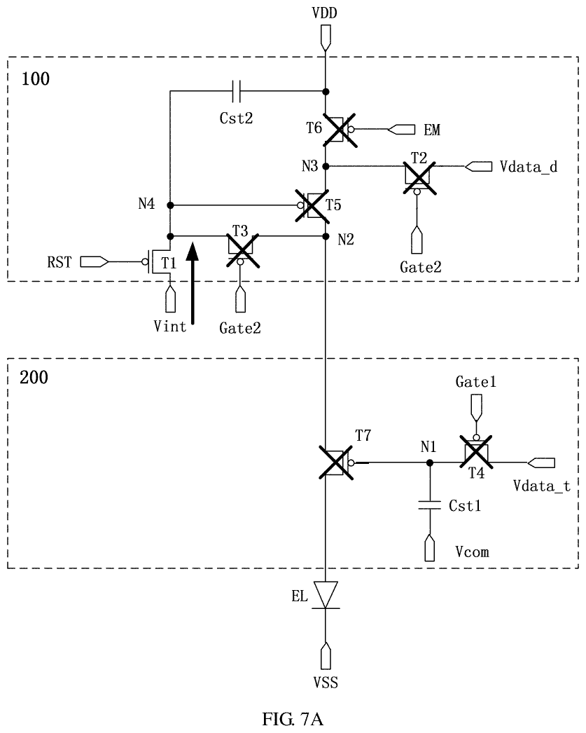

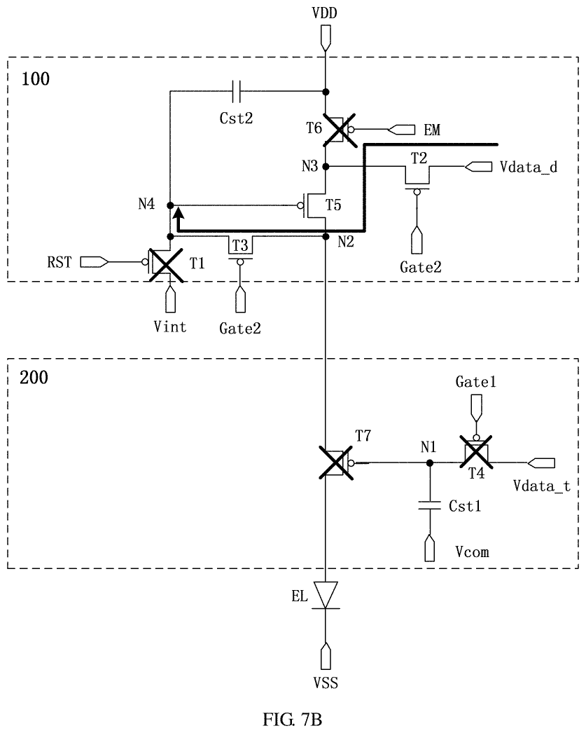

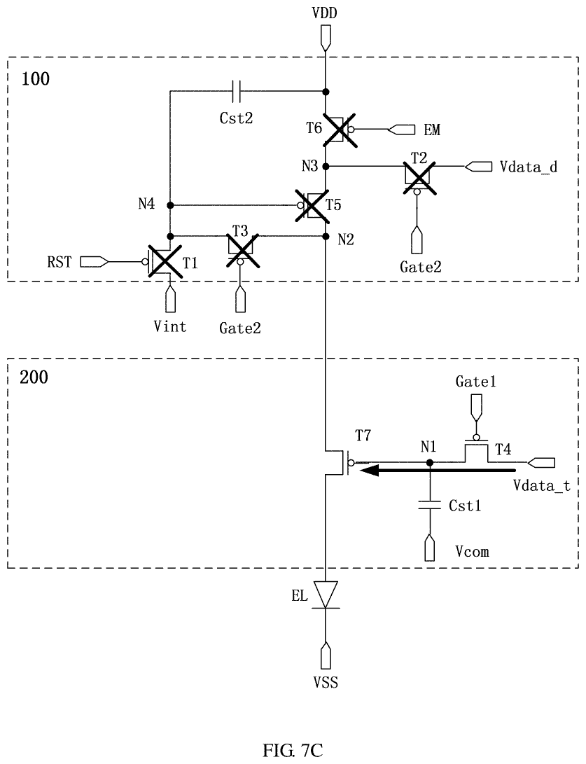

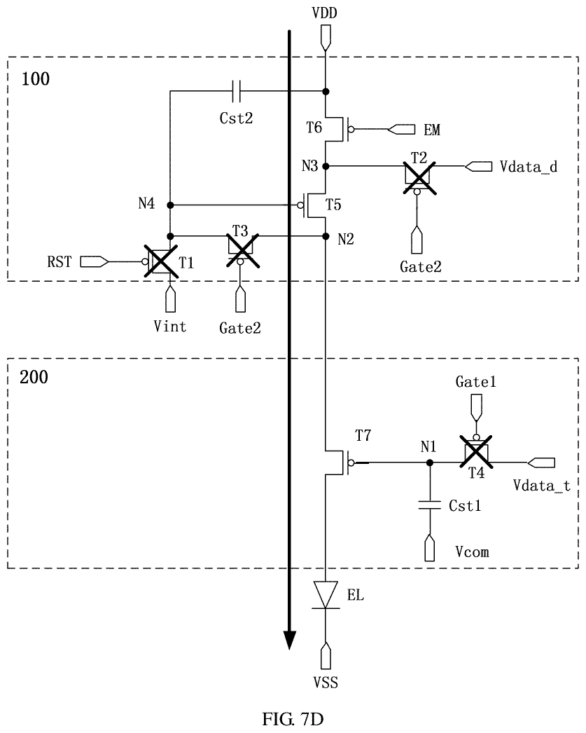

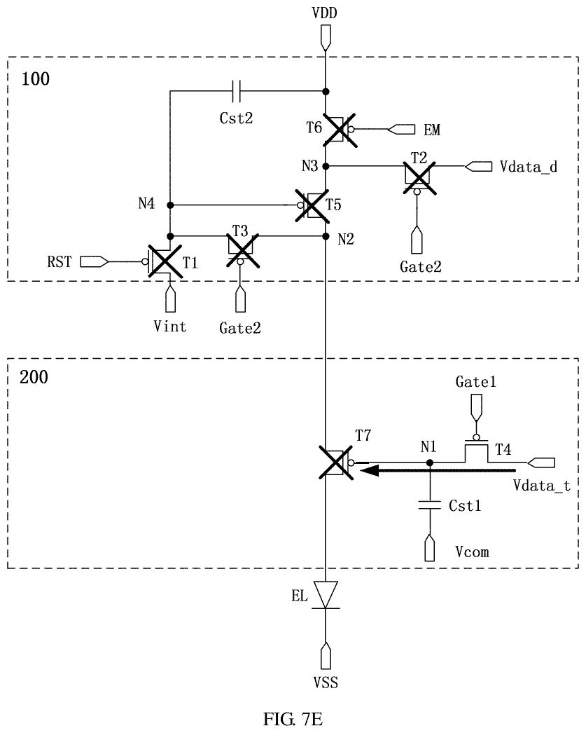

Each phase of the display period of the pixel circuit 10 and each step of the driving method of the pixel circuit 10 are exemplarily described below with reference to FIG. 6A and FIG. 7A to FIG. 7E.

FIG. 7A is a schematic diagram of the pixel circuit 10 illustrated in FIG. 5 in the reset phase REST. As illustrated in FIG. 6A and FIG. 7A, in the reset phase REST, the control terminal of the first transistor T1 connected to the reset scanning terminal RST receives the valid level, and the control terminals of the second transistor T2 to the sixth transistor T6 receive the invalid level. Therefore, in the reset phase REST, the first transistor T1 is turned on, the second transistor T2 to the sixth transistor T6 are turned off. In this case, the reset voltage (for example, the first reset signal) provided by the reset voltage terminal Vint is written to the gate electrode (i.e., the fourth node N4) of the fifth transistor T5 to reset the gate electrode of the fifth transistor T5 and the second capacitor Cst2 (i.e., to reset the current control circuit 100). For example, the voltage value of the above reset voltage may be low (for example, equal to zero). As illustrated in FIG. 6A, because the time control turn-off data signal (i.e., the invalid signal) is provided to the time control circuit 200 in the time control turn-off data signal writing sub-phase CDR of the previous display period, the seventh transistor T7 is turned off.

FIG. 7B is a schematic diagram of the pixel circuit 10 illustrated in FIG. 5 in the display data writing and compensation phase COMP. As illustrated in FIG. 6A and FIG. 7B, in the display data writing and compensation phase COMP, the second transistor T2 and the third transistor T3 connected to the second scanning terminal Gate2 receive the valid level, and thus are in the turn-on state. The first transistor T1 and the fourth transistor T4 receive the invalid level and are turned off. In this case, the second transistor T2 connected to the display data terminal Vdata_d writes the display data signal to the first electrode (i.e., the second node N2) of the fifth transistor T5. Because the voltage value of the reset voltage may be low, the fifth transistor T5 may be turned on, and the voltage (Vdata_d-Vth) of the second electrode of the fifth transistor T5 may be written to the gate electrode (i.e., the fourth node N4) of the fifth transistor T5 through the turned-on third transistor T3. Here, Vth is the threshold voltage of the fifth transistor T5.

For example, as illustrated in FIG. 6A, because the time control turn-off data signal is provided to the time control circuit 200 in the time control turn-off data signal writing sub-phase CDR of the previous display period, the seventh transistor T7 is turned off. Therefore, although no other transistor is provided between the fifth transistor T5 and the seventh transistor T7, the turned-off seventh transistor T7 allows the pixel circuit 10 to have no leakage problem in the display data writing and compensation phase COMP and thus the light-emitting element ELEL can not emit light in the display data writing and compensation phase COMP.

For example, the driving method of the pixel circuit 10 further includes the following step S141: enabling the light-emitting control signal to be at an invalid level in the display data writing and compensation phase COMP. For example, as illustrated in FIG. 6A and FIG. 7B, the sixth transistor T6 can be turned off by allowing the light-emitting control signal to be at an invalid level in the display data writing and compensation phase COMP, and therefore the driving power supply voltage output by the first voltage terminal VDD may be avoided from being applied to the first electrode of the fifth transistor T5 through the sixth transistor T6, thereby preventing the compensation effect of the pixel circuit 10 from being affected.

FIG. 7C is a schematic diagram of the pixel circuit 10 illustrated in FIG. 5 in the time data writing sub-phase DR. As illustrated in FIG. 6A and FIG. 7C, in the time data signal writing sub-phase DR, only the fourth transistor T4 connected to the time scanning terminal Gate1 receives the valid level and thus is in the turn-on state, and the first transistor T1 to the third transistor T3, the fifth transistor T5, and the sixth transistor T6 are turned off. In this case, the time data signal provided by the time data terminal Vdata_t is written to the gate electrode of the seventh transistor T7 through the turned-on fourth transistor T4 and stored in the second capacitor Cst2. Whether the seventh transistor T7 is turned on or not depends on the time data signal stored in the second capacitor Cst2. For example, in the case where the time data signal is at a valid level (for example, a low level), the seventh transistor T7 is turned on; and for another example, in the case where the time data signal is at an invalid level (for example, a high level), the seventh transistor T7 is turned off.

For example, the driving method of the pixel circuit 10 further includes the following step S111: allowing the light-emitting control signal to be at an invalid level in the time data signal writing sub-phase DR.

For example, in step S111, the sixth transistor T6 can be turned off by allowing the light-emitting control signal to be at an invalid level in the time data signal writing sub-phase DR. In this case, the driving power supply voltage provided by the first voltage terminal VDD cannot be applied to the first electrode of the fifth transistor T5 through the turned-on sixth transistor T6, and thus cannot be used to generate the driving current, thereby preventing the light-emitting element EL from emitting light in the time data signal writing sub-phase DR (in the case where the time data signal is effective valid signal).

FIG. 7D is a schematic diagram of the pixel circuit 10 illustrated in FIG. 5 in the effective light-emitting sub-phase EEML. As illustrated in FIG. 6A and FIG. 7D, in the effective light-emitting sub-phase EEML, the light-emitting control signal is at a valid level, and therefore the sixth transistor T6 is turned on. In addition, the fifth transistor T5 is turned on, and the driving current Ids generated in the fifth transistor T5 can be expressed by the foregoing expression (1). It can be seen from the expression (1) that the driving current of the fifth transistor T5 is independent of the threshold voltage Vth of the fifth transistor T5, thereby improving the accuracy of the gray level of the pixel unit including the pixel circuit 10 described above.

As illustrated in FIG. 7D, the time control circuit 200 includes the second driving transistor 210 (for example, the seventh transistor T7), and the current control circuit 100 is further configured to receive the driving power supply voltage from the first voltage terminal. In the effective light-emitting sub-phase EEML, if the time control circuit 200 is turned on, the driving current from the first voltage terminal and used for the light-emitting element EL only passes through the light-emitting control transistor 150, the first driving transistor 110 (for example, the sixth transistor T6), and the second driving transistor 210. For example, because no other transistor is provided between the first driving transistor 110 and the second driving transistor 210, based on the operating characteristics of the light-emitting element EL (the micro LED), the structure complexity of the pixel circuit 10 may be reduced, the aperture ratio and resolution of the pixel unit including the pixel circuit 10 and the display panel including the pixel circuit 10 may be improved, and the difficulty and cost of manufacturing the pixel unit including the pixel circuit 10 and the display panel including the pixel circuit 10 may be reduced.

For example, the driving method of the pixel circuit 10 further includes the following step S112: allowing the light-emitting control signal to be at a valid level in the effective light-emitting sub-phase.

For example, in step S112, the sixth transistor T6 can be turned on by allowing the light-emitting control signal to be at a valid level in the effective light-emitting sub-phase EEML. In this case, the driving power supply voltage provided by the first voltage terminal VDD may be applied to the first electrode of the fifth transistor T5 through the turned-on six transistor T6 and used to generate the driving current (for driving the light-emitting element EL to emit light).

As illustrated in FIG. 6A, the time data signal includes a plurality of sub-phase time data signals in one-to-one correspondence to a plurality of light-emitting phases (for example, a plurality of time data signal writing sub-phases DR of a plurality of light-emitting phases); and for each of the plurality of light-emitting phases, the driving method of the pixel circuit 10 further includes the following steps S113 and S114.

Step S113: providing a corresponding one of the plurality of sub-phase time data signals to the time control circuit 200 in the time data signal writing sub-phase DR.

Step S114: controlling whether to turn on the time control circuit according to the corresponding one of the plurality of sub-phase time data signals in the effective light-emitting sub-phase EEML.

As illustrated in FIG. 5, FIG. 6A and FIG. 7C, in the time data signal writing sub-phase DR, the time scanning terminal Gate1 provides a valid signal to the gate electrode of the fourth transistor T4, which allows the fourth transistor T4 to be turned on, thereby enabling the time data signal receiving terminal Vdata_t to write the corresponding time data signal (that is, the corresponding one of the plurality of sub-phase time data signals) to the gate electrode of the seventh transistor T7 and the first capacitor Cst1 through the turned-on fourth transistor T4.

As illustrated in FIG. 5, FIG. 6A, and FIG. 7C, subsequent to writing the corresponding time data signal, the time data signal stored in the first capacitor Cst1 controls whether the time control circuit 200 is turned on. In an example, as illustrated in FIG. 6A, in the first light-emitting phase EM1, the second light-emitting phase EM2, and the N-th light-emitting phase EMn, the time data signals written to the first capacitor Cst1 are the valid level (for example, low level 0), the invalid level (for example, high level 1), and the valid level (for example, low level 0), respectively. In this case, in the effective light-emitting sub-phases of the first light-emitting phase EM1, the second light-emitting phase EM2, and the N-th light-emitting phase EMn, the time control circuit 200 is in the turn-on state, the turn-off state, and the turn-on state, respectively. Therefore, in the effective light-emitting sub-phase EEML, whether the time control circuit 200 is turned on may be determined according to the corresponding one of the plurality of sub-phase time data signals.

For example, in the effective light-emitting sub-phase EEML, if the corresponding one of the plurality of sub-phase time data signals enables the time control circuit 200 to be turned off, the light-emitting element EL does not emit light; and if the corresponding one of the plurality of sub-phase time data signals enables the time control circuit 200 to be turned on, the light-emitting element EL emits light according to the display data signal. Therefore, in the above example, in the effective light-emitting sub-phases EEML of the first light-emitting phase EM1, the second light-emitting phase EM2, and the N-th light-emitting phase EMn, the light-emitting element EL is in the light-emitting state, the non-light-emitting state, and the light-emitting state, respectively.

As illustrated in FIG. 5 and FIG. 6A, the current control circuit 100 further includes the light-emitting control transistor 150 (for example, the sixth transistor T6). The control terminal of the light-emitting control transistor 150 is configured to receive the light-emitting control signal. The current control circuit 100 and the light-emitting control transistor 150 are configured to be turned on in the case where the light-emitting control signal is at a valid level and turned off in the case where the light-emitting control signal is at an invalid level. For example, as illustrated in FIG. 6A, the current control circuit 100 and the light-emitting control transistor 150 are configured to be turned on in the effective light-emitting sub-phase EEML, and turned off in the part of the display period other than the effective light-emitting sub-phase EEML.

FIG. 7E is a schematic diagram of the pixel circuit 10 illustrated in FIG. 5 in the time control turn-off phase CS. As illustrated in FIG. 6A and FIG. 7E, in the time control turn-off phase CS, only the fourth transistor T4 connected to the time scanning terminal Gate1 receives the valid level and thus is in the turn-on state. The time control turn-off data signal (the invalid signal) provided by the time data terminal Vdata_t is written to the gate electrode of the seventh transistor T7 through the turned-on fourth transistor T4 and stored in the second capacitor Cst2, which enables the seventh transistor T7 to be in the turn-off state prior to the time data signal writing sub-phase DR of the next display period, so that the conductive path from the driving transistor T5 to the light-emitting element EL is cut off, and the light-emitting element EL is prevented from being unnecessarily driven. In addition, in the time control turn-off phase CS, the first transistor T1 to the third transistor T3, the fifth transistor T5, and the sixth transistor T6 are turned off.

As illustrated in FIG. 5 and FIG. 6A, the time control turn-off phase CS includes the time control turn-off data signal writing sub-phase CDR and the turn-off waiting sub-phase CWT subsequent to the time data signal writing sub-phase DR; and the driving method of the pixel circuit 10 further includes the following steps S121 and S122.

Step S121: providing the time control turn-off data signal to the time control circuit 200 in the time control turn-off data signal writing sub-phase CDR.

Step S122: turning off the time control circuit 200 in the turn-off waiting sub-phase CWT according to the time control turn-off data signal.

For example, as illustrated in FIG. 5 and FIG. 6A, by providing the time control turn-off data signal to the time control circuit 200 in the time control turn-off data signal writing sub-phase CDR, the time control circuit 200 can be turned off, and therefore in the case where no other transistor is provided between the fifth transistor T5 and the seventh transistor T7, the pixel circuit 10 is prevented from leaking in the compensation phase of the next display period, and the light emission of the light-emitting element EL caused by the leakage current is prevented.

For example, as illustrated in FIG. 5 and FIG. 6A, in the turn-off waiting sub-phase CWT, the time control circuit 200 is turned off according to the time control turn-off data signal. In an example, as illustrated in FIG. 5 and FIG. 6A, the light-emitting control signal is at an invalid level in the turn-off data signal writing phase, and the light-emitting control signal is at a valid level in the turn-off waiting sub-phase CWT. In this case, the light-emitting control signal can be implemented as a periodically repeated signal, thereby reducing the difficulty of designing the light-emitting control signal. It should be noted that the light-emitting control signal is at the valid level in the turn-off waiting sub-phase CWT, however because the time control circuit 200 is turned off in the turn-off waiting sub-phase CWT, the light-emitting element EL does not emit light in the turn-off waiting sub-phase.

It should be noted that the light-emitting control signal provided by the light-emitting control terminal EM is not limited to the high level illustrated in FIG. 6A. According to practical requirements, the light-emitting control signal provided by the light-emitting control terminal EM may also be at the low level in the reset phase REST (with reference to FIG. 6B); and in this case, the sixth transistor T6 is turned on. Because the seventh transistor T7 is turned off, turning on the sixth transistor T6 does not cause the light-emitting element to emit light, nor affect the reset function of the reset circuit (the first transistor T1). For example, by allowing the light-emitting control signal to be at the low level in the reset phase REST, the low level of the light-emitting control signal may be periodically repeated in time, thereby simplifying the difficulty of designing the light-emitting control signal.

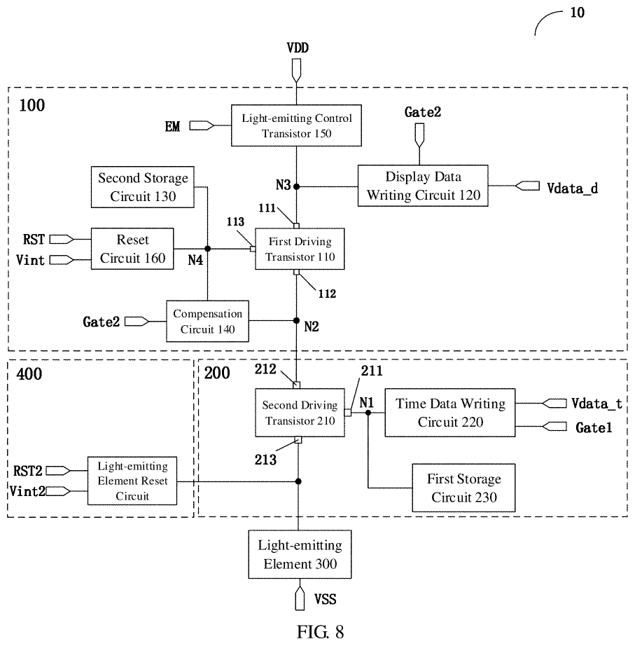

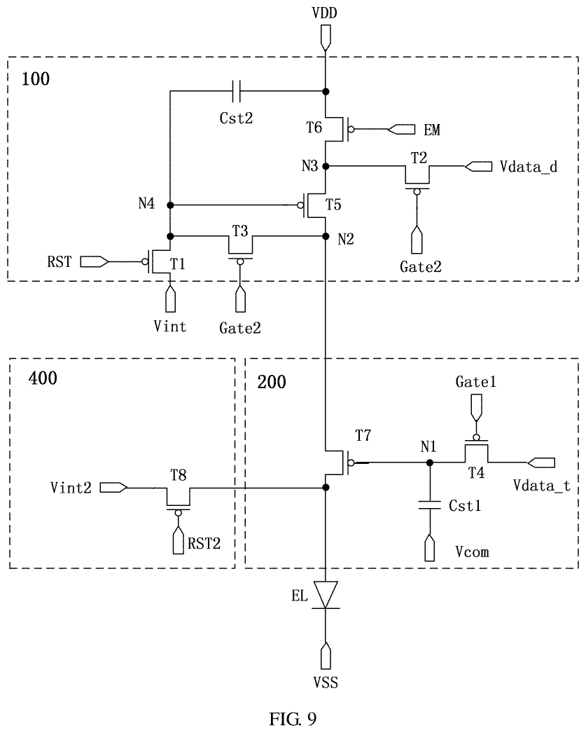

FIG. 8 is another exemplary block diagram of the pixel circuit 10 provided by at least one embodiment of the present disclosure, and FIG. 9 is an exemplary circuit diagram of the pixel circuit 10 illustrated in FIG. 8. The pixel circuit 10 illustrated in FIG. 8 and FIG. 9 is similar to the pixel circuit 10 illustrated in FIG. 4 and FIG. 5. Therefore, only the differences may be described herein, and the similarities may not be described again.

As illustrated in FIG. 8, the pixel circuit 10 further includes a light-emitting element reset circuit 400. As illustrated in FIG. 8, the light-emitting element reset circuit 400 is connected to the first terminal of the light-emitting element EL; and the light-emitting element reset circuit 400 is configured to reset the light-emitting element EL in response to the reset signal of the light-emitting element EL, thereby turning off the light-emitting element EL.

For example, by providing the light-emitting element reset circuit 400 in the pixel circuit 10, the light-emitting element EL may be quickly prevented from emitting light, so that the problem of residual light of the light-emitting element EL may be alleviated. For example, the light-emitting element EL may be reset subsequent to each effective light-emitting sub-phase EEML. For another example, the reset signal may be provided to the first terminal of the light-emitting element EL to reset the light-emitting element EL in the time control turn-off phase CS (for example, only in the time control turn-off phase CS). In this case, the time control turn-off phase CS includes the reset phase (the light-emitting element reset phase).

As illustrated in FIG. 9, the light-emitting element reset circuit 400 includes an eighth transistor T8, and the eighth transistor T8 includes a control terminal, a first terminal, and a second terminal. As illustrated in FIG. 9, the control terminal of the eighth transistor T8 is connected to the second reset scanning terminal RST2 to receive the second reset scanning signal provided by the second reset scanning terminal RST2; the first terminal of the eighth transistor T8 is connected to the second reset voltage terminal Vint2 to receive the second reset voltage provided by the second reset voltage terminal Vint2; and the second terminal of the eighth transistor T8 is connected to the first terminal (the anode) of the light-emitting element EL. The eighth transistor T8 is configured to apply the second reset voltage provided by the second reset voltage terminal Vint2 to the first terminal (the anode) of the light-emitting element EL in response to the second reset scanning signal to reset the light-emitting element EL (so that the light-emitting element EL is turned off). For example, the second reset voltage may be at a low level (for example, zero); and for example, the second reset voltage terminal Vint2 may be a grounded terminal. For example, by applying the second reset voltage to the first terminal (the anode) of the light-emitting element EL, the light-emitting element EL may be quickly caused not to emit light, thereby alleviating the problem of residual light of the light-emitting element EL. For example, the second reset voltage may be applied to the first terminal (the anode) of the light-emitting element EL subsequent to each effective light-emitting sub-phase EEML.

For example, the driving method of the pixel circuit illustrated in FIG. 9 is similar to the driving method of the pixel circuit illustrated in FIG. 5, and details may not be repeated herein. For example, for the pixel circuit illustrated in FIG. 9, the driving method of the pixel circuit further includes providing the second reset signal to a terminal of the light-emitting element EL to reset the light-emitting element EL.

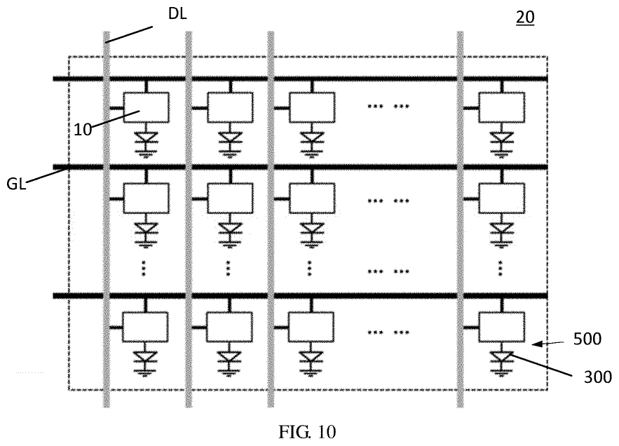

At least one embodiment of the present disclosure further provides a display panel, and the display panel includes the pixel circuit 10 (for example, the pixel circuit 10 illustrated in FIG. 5, or the pixel circuit 10 illustrated in FIG. 9) provided by any one of the embodiments of the present disclosure. FIG. 10 illustrates an exemplary structural diagram of a display panel 20 provided by at least one embodiment of the present disclosure. As illustrated in FIG. 10, the display panel 20 includes a plurality of pixel units 500, and the plurality of pixel units 500 are arranged in a plurality of rows and a plurality of columns.

For example, each pixel unit 500 includes the pixel circuit 10 provided by any one of the embodiments of the present disclosure, so that the display panel 20 includes a plurality of pixel circuits 10, and the plurality of pixel circuits 10 are arranged in a plurality of rows and a plurality of columns. For example, as illustrated in FIG. 10, each pixel unit 500 further includes the light-emitting element EL, the first terminal (the anode) of the light-emitting element EL is connected to the pixel circuit 10, and the second terminal (the cathode) of the light-emitting element EL is, for example, grounded.

For example, as illustrated in FIG. 10, the display panel 20 further includes scanning lines GL and data lines DL. For example, a plurality of scanning lines GL (for example, four scanning lines GL) may be provided between two adjacent rows of pixel circuits 10 in the column direction, and a plurality of data lines DL (for example, two data lines DL) may be provided between two adjacent rows of pixel circuits 10 in the row direction.

For example, at least one pixel circuit 10 (for example, each pixel circuit 10) is connected to four scanning lines GL and two data lines DL; the four scanning lines GL are implemented as a current scanning line, a time scanning line, a reset scanning line, and a light-emitting control line, respectively, and are configured to provide a current scanning signal, a time scanning signal, a reset scanning signal, and a light-emitting control signal, respectively; and the above two data lines DL are implemented as a time data line and a display data line, respectively, and are configured to provide a time data signal and a display data signal, respectively.

For example, by setting the time control turn-off phase CS, in the case where no transistor is provided between the first driving transistor 110 and the second driving transistor 210 of the pixel circuit 10 and/or in the case where no transistor is provided between the second driving transistor 210 and the light-emitting element 310 (e.g., the light-emitting element EL), the light-emitting element (micro LED) may display, for example, a low gray level when operating at the high current density, thereby reducing the number of transistors in the pixel circuit 10, reducing the structure complexity of the pixel circuit 10, improving the aperture ratio and resolution of the pixel unit and the display panel, and reducing the difficulty and cost of manufacturing the pixel unit and the display panel.

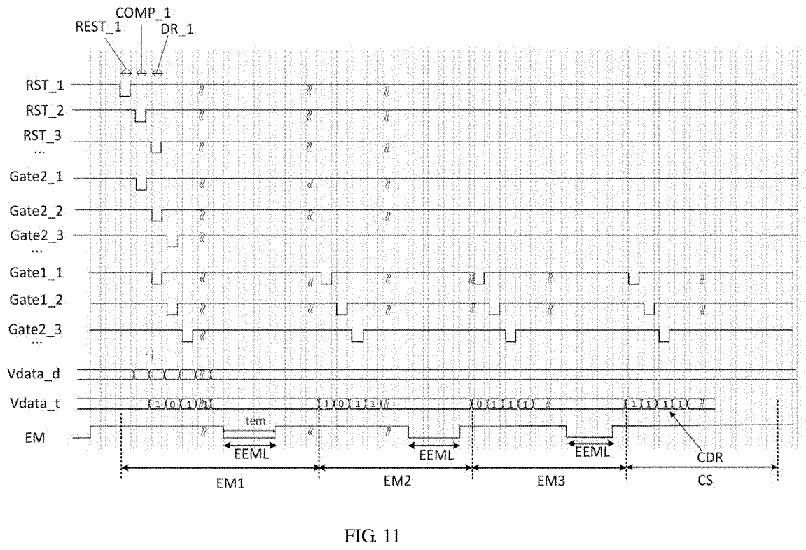

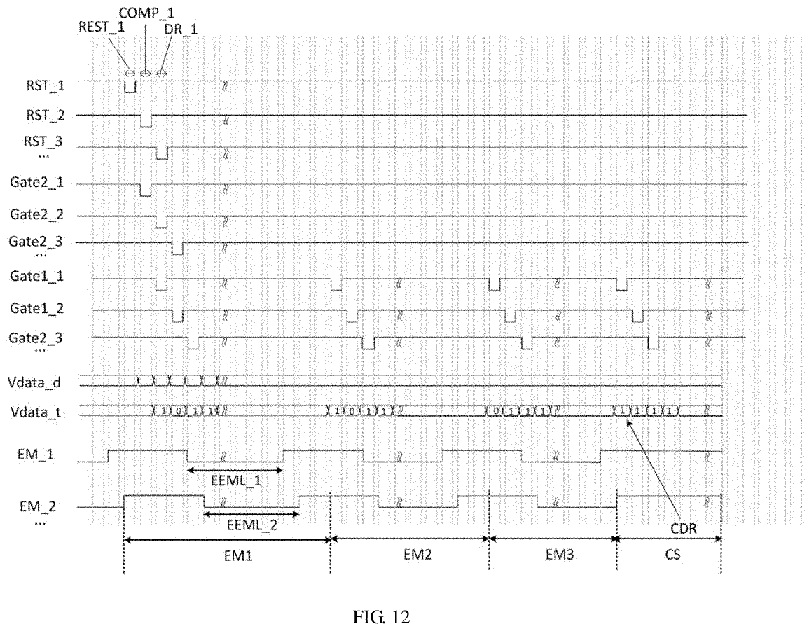

At least one embodiment of the present disclosure further provides a driving method of a display panel, including: performing the driving method of the pixel circuit provided by any one of the embodiments of the present disclosure on each of the plurality of pixel circuits. FIG. 11 is a timing diagram of driving a display panel provided by at least one embodiment of the present disclosure, and FIG. 12 is another timing diagram of driving a display panel provided by at least one embodiment of the present disclosure.

In FIG. 11, FIG. 12 and the following description, RST_1 to RST_3, Gate1_1 to Gate1_3, Gate2_1 to Gate2_3, EM_1 to EM_2, EM, Vdata_d, Vdata_t, etc. are used to represent the corresponding signal terminal and also the corresponding signal.

For example, RST_1 to RST_3 may represent the reset scanning terminals in the pixel circuits in the first row to the third row, respectively, or may represent the reset scanning signals received by the reset scanning terminals in the pixel circuits in the first row to the third row, respectively. For example, Gate1_1 to Gate1_3 may represent the time scanning terminals in the pixel circuits in the first row to the third row, respectively, or may represent the time scanning signals received by the time scanning terminals in the pixel circuits in the first row to the third row, respectively. For example, Gate2_1 to Gate2_3 may represent the current scanning terminals in the pixel circuits in the first row to the third row, respectively, or may represent the current scanning signals received by the current scanning terminals in the pixel circuits in the first row to the third row, respectively. For example, EM may represent the light-emitting control terminals in the pixel circuits in each row, or may represent the light-emitting control signals received by the light-emitting control terminals in the pixel circuits in each row. EM_1 to EM_2 may represent the light-emitting control terminals in the pixel circuits in the first row to the second row, respectively, or may represent the light-emitting control signals received by the light-emitting control terminals in the pixel circuits in the first row to the second row, respectively.

It should be noted that, for clarity, FIG. 11 and FIG. 12 only illustrate timing diagrams of the reset scanning signals, time scanning signals, and reset scanning signals provided to three rows of the pixel circuits, and each scanning signal and light-emitting control signal provided to the pixel circuits in other rows may be set with reference to FIG. 11 and FIG. 12.

As illustrated in FIG. 11 and FIG. 12, the reset scanning signals received from the reset scanning terminals (RST_1 to RST_3) of the pixel circuits in the first row to the third row may be valid signals (or in valid signal), so as to allow the first transistors T1 of the pixel circuits in the first row to the third row to be sequentially turned on and allow the pixel circuits in the first row to the third row to be sequentially reset.

As illustrated in FIG. 11 and FIG. 12, the current scanning signals received from the current scanning terminals (Gate2_1 to Gate2_3) of the pixel circuits in the first row to the third row may be sequentially caused to be effective signals, so as to allow the second transistors T2 of the pixel circuits in the first row to the third row to be sequentially turned on. In this case, the display data signals provided by the display data terminals Vdata_d may be sequentially written to the first electrodes of the fifth transistors T5 of the pixel circuits in the first row to the third row.

As illustrated in FIG. 11 and FIG. 12, the time scanning signals received by the time scanning terminals (Gate1_1 to Gate1_3) of the pixel circuits in the first row to the third row may be sequentially caused to be effective signals, so as to allow the fourth transistors T4 of the pixel circuits in the first row to the third row to be sequentially turned on. In this case, the time data signals provided by the time data terminals Vdata_t may be sequentially written to the seventh transistors T7 of the pixel circuits in the first row to the third row and sequentially stored in the first capacitors of the pixel circuits in the first row to the third row.

As illustrated in FIG. 11 and FIG. 12, for the pixel units in any row, the reset scanning signal received by the reset scanning terminal (for example, RST_1), the current scanning signal received by the current scanning terminal (for example, Gate2_1), and the time scanning signal received by the time scanning terminal (for example, Gate1_1) are at the valid level sequentially.

In an example, as illustrated in FIG. 11, pixel circuits in different rows may be provided with the same light-emitting control signal, so that the light-emitting elements of the pixel circuits in different rows may emit light in the same period, thereby simplifying the driving circuit of the display panel. For example, the light-emitting control terminals of the pixel circuits in the pixel units in different rows are connected to an identical light-emitting control line. For example, the light-emitting time of one light-emitting element in different light-emitting phases may be the same, thereby simplifying the driving circuit of the display panel.

In another example, as illustrated in FIG. 12, the light-emitting control terminals of the pixel circuits in the pixel units in different rows are connected to different light-emitting control lines to receive different light-emitting control signals, and the light-emitting elements of the pixel circuits in different rows emit light in different periods (for example, sequentially emit light). As illustrated in FIG. 12, the time scanning signals received from the light-emitting control terminals (EM_1 to EM_2) of the pixel circuits of the pixel units in the first row to the third row may be sequentially caused to be effective signals, so as to allow the light-emitting elements of the pixel units in the first row to the second row to emit light sequentially.

In this case, for example, after the display data signal and the time data signal are written to the pixel circuits in the corresponding row, the light-emitting elements in the pixel circuits in the row may emit light without writing the display data signal and the time data signal to the pixel circuits of the pixel units in each row. Therefore, in another example, the time required to display a frame of image (that is, the time of the display period) may be reduced according to practical application requirements, thereby improving the frame rate of the display panel and improving the display effect of the display panel.

For example, as illustrated in FIG. 12, after a predetermined period of time after the display data signal and the time data signal are written into the pixel circuits in the corresponding row, the light-emitting elements in the pixel circuits in the row may be caused to emit light, so as to adjust the light-emitting time of the light-emitting elements. For example, as illustrated in FIG. 12, the light-emitting time of the light-emitting elements of the pixel units in adjacent rows at least partially overlap to increase the setting range of the light-emitting time of the light-emitting element. For example, the light-emitting time of the light-emitting elements in the pixel units in different rows may be the same, thereby simplifying the driving circuit of the display panel. For example, the light-emitting time of one light-emitting element in different light-emitting phases may be the same, thereby further simplifying the driving circuit of the display panel.

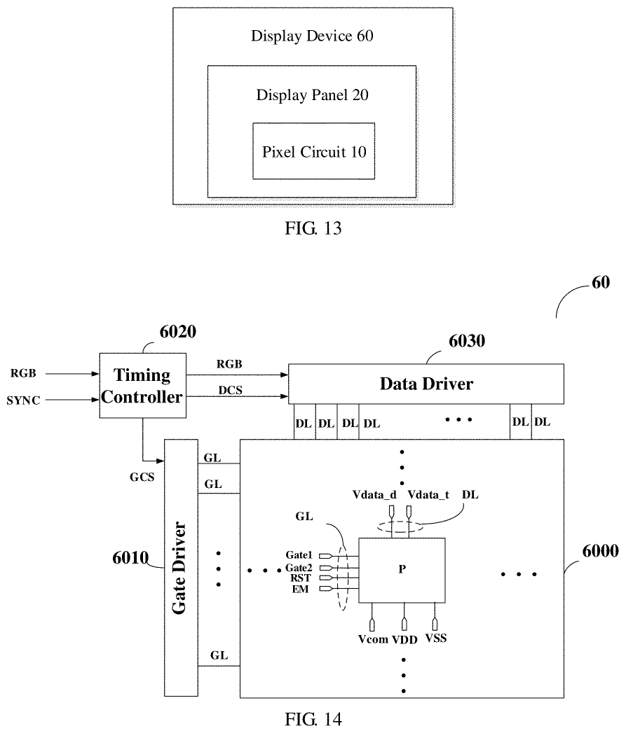

At least one embodiment of the present disclosure further provides a display device including the pixel circuit provided by any one of the embodiments of the present disclosure or the display panel provided by any one of the embodiments of the present disclosure. FIG. 13 is an exemplary block diagram of a display device provided by at least one embodiment of the present disclosure. For example, as illustrated in FIG. 13, the display device includes the pixel circuit provided by any one of the embodiments of the present disclosure or the display panel provided by any one of the embodiments of the present disclosure. The specific settings of the pixel circuit may be refer to the example of the pixel circuit illustrated in FIG. 5 or FIG. 9, the specific settings of the display panel may be refer to the example of the display panel illustrated in FIG. 10, and details are not described herein again.

FIG. 14 is a schematic block diagram of another display device provided by at least one embodiment of the present disclosure. As illustrated in FIG. 14, the display device 60 includes a display panel 6000, a gate driver 6010, a timing controller 6020, and a data driver 6030. For example, the gate driver 6010 includes a plurality of cascaded shift register units and is used to drive a plurality of scanning lines GL; and the data driver 6030 is used to drive a plurality of data lines DL.

As illustrated in FIG. 14, the display panel 6000 includes a plurality of pixel units P defined by the plurality of scanning lines GL crossing with the plurality of data lines DL, and at least one pixel unit P includes the pixel circuit provided by any one of the embodiments of the present disclosure. For example, at least one pixel unit P further includes the light-emitting element (for example, a micro LED).

For example, at least one pixel unit P (for example, each pixel unit P) is connected to four scanning lines GL, two data lines DL, and three voltage lines; the above four scanning lines GL are respectively implemented as a current scanning line (corresponding to the current scanning terminal Gate2), a time scanning line (corresponding to the time scanning terminal Gate1), a reset scanning line (corresponding to the reset scanning terminal RST), and a light-emitting control line (corresponding to the light-emitting control terminal EM), and are respectively configured to provide a current scanning signal, a time scanning signal, a reset scanning signal, and a light-emitting control signal. The above two data lines DL are implemented as a time data line (corresponding to the time data terminal Vdata_t) and a display data line (corresponding to the display data terminal Vdata_d), and are respectively configured to provide a time data signal and a display data signal. The above three voltage lines are respectively implemented as a first voltage line (corresponding to the first voltage terminal VDD), a second voltage line (corresponding to the second voltage terminal VSS), and a common voltage line (corresponding to the common voltage terminal Vcom), and are respectively configured to provide a driving power supply voltage, a second voltage, and a common voltage. For example, the first voltage line, the second voltage line, or the third voltage line may be replaced with corresponding plate-shaped common electrodes (for example, a common anode or a common cathode).

For example, the plurality of scanning lines GL are correspondingly connected to the pixel units P (for example, correspondingly connected to the control terminals of the pixel circuits in the pixel units P) arranged in the plurality of rows. The output terminal of each shift register unit in the gate driving circuit 6010 sequentially outputs the signal to each of the plurality of scanning lines GL, so as to progressively scan the plurality of rows of pixel units P in the display panel 6000. For example, the gate driving circuit 6010 is configured to provide the current scanning signal, the time scanning signal, the reset scanning signal, and the light-emitting control signal to the pixel circuit; and the data driver 6030 is configured to provide the time data signal and the display data signal to the pixel circuit.

For example, the gate driving circuit 6010 and the data driver 6030 are respectively configured to provide the time scanning signal and the turn-off data signal to the pixel circuit in the time control turn-off phase, so as to turn off the time control circuit of the pixel circuit. In this case, in the case where no transistor is provided between the first driving transistor and the second driving transistor of the pixel circuit and/or in the case where no transistor is provided between the second driving transistor of the pixel circuit and the light-emitting element (for example, the light-emitting element EL), the light-emitting element (the micro LED) may display, for example, the low gray level when operating at the high current density, thereby reducing the number of transistors in the pixel circuit and the structure complexity, improving the aperture ratio and resolution of the display device including the pixel circuit, and reducing the difficulty and cost of manufacturing the display device.

As illustrated in FIG. 14, the timing controller 6020 is used to process the image data RGB input from the outside of the display device 60 and to provide the processed image data RGB to the data driver 6030. The timing controller 6020 is further used to output the gate control signal (GCS) and the data control signal (DCS) to the gate driver 6010 and the data driver 6030, respectively, so as to control the gate driver 6010 and the data driver 6030, respectively. It should be noted that the data control signal (DCS) is also referred to as a source control signal (SCS).

For example, the timing controller 6020 is configured to compensate (for example, through an algorithm which can perform calculation, conversion, compensation, etc.) for the data signal to be displayed and then provide the compensated data signal to the data driver 6030.

For example, the data driver 6030 converts digital image data RGB provided from the timing controller 6020 into data signals according to a plurality of data control signals DCS provided by the timing controller 6020. The data driver 6030 provides the data signals to the plurality of data lines DL.

For example, the timing controller 6020 processes the externally input image data RGB so that the processed image data matches the size and resolution of the display panel 6000, and then the timing controller 6020 provides the processed image data to the data driver 6030. The timing controller 6020 uses a synchronization signal or timing control signal (for example, the dot clock DCLK, the data enable signal DE, the horizontal synchronization signal Hsync, and the vertical synchronization signal Vsync, and in FIG. 14, the horizontal synchronization signal Hsync and the vertical synchronization signal Vsync are both expressed by SYNC) input from the outside of the display device 60 to generate a plurality of gate control signals GCS and a plurality of data control signals DCS.

For example, the gate driver 6010 and the data driver 6030 may be implemented as semiconductor chips.

It should be noted that other components (such as the image data encoding/decoding device, the signal decoding circuit, the voltage conversion circuit, the clock circuit, etc.) of the display device 60 may use suitable components, which should be understood by those skilled in the art. Details are not described herein again, and the present disclosure may not be limited in this aspect.

Although the present disclosure has been described in detail in conjunction with the general description and the specific embodiments, some modifications or improvements can be made on the basis of the embodiments of the disclosure, which is obvious to those skilled in the art. Therefore, without deviating from the spirit of the disclosure, these modifications or improvements fall within the protection scope of the present disclosure.

What have been described above are only specific implementations of the present disclosure, the protection scope of the present disclosure is not limited thereto, and the protection scope of the present disclosure should be based on the protection scope of the claims.

1. A driving method of a pixel circuit, wherein the pixel circuit comprises a current control circuit and a time control circuit,
the current control circuit is configured to receive a display data signal and a light-emitting control signal, control, according to the light-emitting control signal, whether to generate a driving current, and control a current magnitude of the driving current flowing through the current control circuit according to the display data signal,
the time control circuit is configured to receive the driving current, receive a time data signal, and control passing time of the driving current according to the time data signal,
a display period of the pixel circuit comprises a plurality of consecutive light-emitting phases and a time control turn-off phase, and
in the display period, the driving method comprises:
driving, by the current control circuit and the time control circuit according to the display data signal and the light-emitting control signal received by the current control circuit and the time data signal received by the time control circuit, a light-emitting element to emit light in the plurality of consecutive light-emitting phases; and
causing the time control circuit to be turned off in the time control turn-off phase according to a time control turn-off data signal received by the time control circuit.

2. The driving method according to claim 1, wherein each of the plurality of light-emitting phases comprises a time data signal writing sub-phase and an effective light-emitting sub-phase subsequent to the time data signal writing sub-phase; and
for each of the plurality of light-emitting phases, the driving method further comprises:
causing the light-emitting control signal to be at an invalid level in the time data signal writing sub-phase; and
causing the light-emitting control signal to be at a valid level in the effective light-emitting sub-phase.

3. The driving method according to claim 1 or 2, wherein the time data signal comprises a plurality of sub-phase time data signals in one-to-one correspondence with the plurality of light-emitting phases; and
for each of the plurality of light-emitting phases, the driving method further comprises:
providing a corresponding one of the plurality of sub-phase time data signals to the time control circuit in the time data signal writing sub-phase; and
controlling whether to turn on the time control circuit according to the corresponding one of the plurality of sub-phase time data signals in the effective light-emitting sub-phase.

4. The driving method according to claim 3, wherein in the effective light-emitting sub-phase,
in a case where the corresponding one of the plurality of sub-phase time data signals causes the time control circuit to be turned off, the light-emitting element does not emit light; and
in a case where the corresponding one of the plurality of sub-phase time data signals causes the time control circuit to be turned on, the light-emitting element emits light according to the display data signal.

5. The driving method according to claim 1, wherein the time control turn-off phase comprises a time control turn-off data signal writing sub-phase and a turn-off waiting sub-phase subsequent to the time control turn-off data signal writing sub-phase; and
the driving method further comprises:
providing the time control turn-off data signal to the time control circuit in the time control turn-off data signal writing sub-phase; and
turning off the time control circuit according to the time control turn-off data signal in the turn-off waiting sub-phase.

6. The driving method according to claim 2, wherein the current control circuit comprises a first driving transistor, and at least an initial light-emitting phase of the plurality of consecutive light-emitting phases further comprises a display data writing and compensation phase prior to the effective light-emitting sub-phase; and
the driving method further comprises:
writing the display data signal to the first driving transistor and performing threshold compensation on the first driving transistor in the display data writing and compensation phase to control a current magnitude of a driving current flowing through the first driving transistor according to the display data signal.

7. The driving method according to claim 6, further comprising: causing the light-emitting control signal to be at an invalid level in the display data writing and compensation phase.

8. The driving method according to claim 6 or 7, wherein the current control circuit further comprises a light-emitting control transistor;
a control terminal of the light-emitting control transistor is configured to receive the light-emitting control signal; and
the current control circuit and the light-emitting control transistor are configured to be turned on in a case where the light-emitting control signal is at a valid level and to be turned off in a case where the light-emitting control signal is at an invalid level.

9. The driving method according to claim 6, wherein the time control circuit comprises a second driving transistor, and the current control circuit is further configured to receive a driving power supply voltage from a first voltage terminal; and
in the effective light-emitting sub-phase, in a case where the time control circuit is in a turn-on state, the driving current from the first voltage terminal and for the light-emitting element only passes through the light-emitting control transistor, the first driving transistor, and the second driving transistor.

10. The driving method according to claim 2, wherein at least an initial light-emitting phase of the plurality of consecutive light-emitting phases further comprises a reset phase prior to the effective light-emitting sub-phase; and
the driving method further comprises:
providing a first reset signal to the current control circuit to reset the current control circuit, and providing a second reset signal to one terminal of the light-emitting element to reset the light-emitting element in the reset phase.

11. The driving method according to claim 1, wherein the time control turn-off phase comprises a reset phase; and
the driving method further comprises: providing a reset signal to a first terminal of the light-emitting element to reset the light-emitting element in the reset phase.

12. A driving method of a display panel, wherein the display panel comprises a plurality of pixel circuits, the plurality of pixel circuits are arranged in a plurality of rows and a plurality of columns, and
wherein each of the plurality of pixel circuits comprises a current control circuit and a time control circuit,
the current control circuit is configured to receive a display data signal and a light-emitting control signal, control, according to the light-emitting control signal, whether to generate a driving current, and control a current magnitude of the driving current flowing through the current control circuit according to the display data signal,
the time control circuit is configured to receive the driving current, receive a time data signal, and control passing time of the driving current according to the time data signal,
a display period of the pixel circuit comprises a plurality of consecutive light-emitting phases and a time control turn-off phase, and
the driving method of the display panel comprises: performing following operations on each of the plurality of pixel circuits in the display period of each of the plurality of pixel circuits:
driving, by the current control circuit and the time control circuit according to the display data signal and the light-emitting control signal received by the current control circuit and the time data signal received by the time control circuit, a light-emitting element to emit light in the plurality of consecutive light-emitting phases; and
causing the time control circuit to be turned off in the time control turn-off phase according to a time control turn-off data signal received by the time control circuit.

13. The driving method of the display panel according to claim 12,
wherein the pixel circuits in different rows are provided with a same light-emitting control signal, to cause the pixel circuits in different rows to emit light in a same period.

14. A pixel circuit, comprising a current control circuit and a time control circuit,
wherein the current control circuit is configured to receive a display data signal and a light-emitting control signal, receive a driving power supply voltage from a first voltage terminal, control whether to generate a driving current according to the light-emitting control signal, and control a current magnitude of the driving current flowing through the current control circuit according to the display data signal;
the time control circuit is configured to receive the driving current, receive a time data signal, and control passing time of the driving current according to the time data signal;
the current control circuit comprises a first driving transistor and a light-emitting control transistor;
the time control circuit comprises a second driving transistor; and
during an operation, the driving current from the first voltage terminal and used for a light-emitting element only passes through the first driving transistor, the second driving transistor, and the light-emitting control transistor.

15. The pixel circuit according to claim 14, wherein a first terminal of the light-emitting control transistor is connected to the first voltage terminal;
a second terminal of the light-emitting control transistor is connected to a first terminal of the first driving transistor;
a second terminal of the first driving transistor is directly connected to a first terminal of the second driving transistor; and
a second terminal of the second driving transistor is connected to a first terminal of the light-emitting element.

16. The pixel circuit according to claim 14, further comprising a light-emitting element reset circuit, wherein the light-emitting element reset circuit is connected to a first terminal of the light-emitting element; and
the light-emitting element reset circuit is configured to reset the light-emitting element in response to a light-emitting element reset scanning signal to turn off the light-emitting element.

17. The pixel circuit according to claim 14, wherein the time control circuit further comprises a first storage circuit and a time data writing circuit;
the second driving transistor comprises a control terminal, and is configured to control, in response to the time data signal, a turn-on state of the second driving transistor and whether to allow the driving current to pass through the second driving transistor;
the time data writing circuit is connected to the control terminal of the second driving transistor, and is configured to write the time data signal to the control terminal of the second driving transistor in response to a time scanning signal; and
the first storage circuit is connected to the control terminal of the second driving transistor, and is configured to store the time data signal written by the time data writing circuit.

18. The pixel circuit according to claim 14, wherein the current control circuit further comprises a display data writing circuit, a second storage circuit, a compensation circuit, and a reset circuit,
wherein the light-emitting control transistor is configured to apply a first voltage provided by the first voltage terminal to a first terminal of the first driving transistor in response to the light-emitting control signal;
the display data writing circuit is connected to the first terminal of the first driving transistor, and is configured to write the display data signal to the first terminal of the first driving transistor in response to a current scanning signal;
the second storage circuit is connected to a control terminal of the first driving transistor, and is configured to store the display data signal written by the display data writing circuit;
the compensation circuit is connected to the control terminal of the first driving transistor and a second terminal of the first driving transistor, and is configured to compensate for the first driving transistor in response to the current scanning signal; and
the reset circuit is connected to the control terminal of the first driving transistor, and is configured to apply a reset voltage provided by a reset voltage terminal to the control terminal of the first driving transistor in response to a reset scanning signal.

19. A display panel, comprising the pixel circuit according to claim 14.

20. A display device, comprising the pixel circuit according to claim 14.
